(19) United States
(12) Patent Application Publication
(10) Pub. No.: US 2011/0291985 A1
(43) Pub. Date: Dec. 1, 2011

(54) INFORMATION TERMINAL, SCREEN COMPONENT DISPLAY METHOD, PROGRAM, AND RECORDING MEDIUM

(76) Inventors: Takeshi Wakako, Osaka (JP); Hiroyuki Morimoto, Osaka (JP)

(21) Appl. No.: 13/050,272

(22) Filed: Mar. 17, 2011

(30) Foreign Application Priority Data
May 28, 2010 (JP) 2010-123328
Feb. 22, 2011 (JP) 2011-036176

(51) Int. Cl. G06F 3/045

(52) U.S. Cl. 345/174; 345/173

(57) ABSTRACT

An information terminal that enables a desired screen component to be easily found and an original state prior to movement of a screen component to be easily discerned is provided. An information terminal includes: a display surface that displays a plurality of icons; a contactless input unit that detects information related to a distance of a finger that designates the icons, from the display surface and information related to a position of the finger in a plane parallel to the display surface; and an icon movement rendering unit that motion-displays in sequence the icons selected according to a selection rule, to such positions on the display surface obtained according to a display rule based on the information related to the distance and the information related to the position.

### BACKGROUND OF THE INVENTION

1. Field of the Invention

The present invention relates to an information terminal, a screen component display method, and the like.

2. Related Art of the Invention

Information terminals such as PDAs, smartphones, tablet PCs, and car navigation systems are becoming widely used. For downsizing purposes, such information terminals typically adopt a touch panel used to input information by touching an icon or other screen components of a GUI (Graphical User Interface) displayed on a display with a touch pen or a finger. With a touch panel, screen components including a plurality of icons are displayed on a display screen, and by touching an icon with a stylus or a finger, the icon is decided on and an application program assigned to the icon can be activated.

While such information terminals require that a touch panel be touched in order to decide on an icon, an information terminal is disclosed in which, by bringing a finger close to a touch panel, icons on the touch panel are gathered around the finger (for example, refer to Japanese Patent Laid-Open No. 2008-117371). FIG. 24 is a diagram illustrating a display screen of an information terminal described in Japanese Patent Laid-Open No. 2008-117371. When a finger approaches a space above a detection area 100 illustrated in the center of FIG. 24, icons 102 displayed until then at both ends of a display screen 101 are gathered to the center (refer to the arrows).

However, with the information terminal according to Japanese Patent Laid-Open No. 2008-117371 described above, since all displayed icons move so as to surround the finger, a problem exists in that a desired icon is difficult to find when a large number of icons are displayed.

In addition, since all displayed icons move at once, it is difficult to discern original positions of the icons prior to movement thereof.

The present invention is made in considerations of problems existing in the conventional information terminal described above, and an object of the present invention is to provide an information terminal and a screen component display method that enable a desired screen component to be easily found and an original state of a screen component prior to movement thereof to be easily discerned.

To achieve the above object, the 1^{st} aspect of the present invention is an information terminal comprising:

a display surface that displays a plurality of screen components;

a motion display detecting unit that detects information related to a distance from the display surface to a designating object that designates the screen components, and information related to a position of the designating object in a plane parallel to the display surface; and

a screen component movement rendering unit that motion-displays in sequence the screen components selected according to a selection rule, to such positions on the display surface obtained according to a display rule, based on the information related to the distance and the information related to the position.

The 2^{nd} aspect of the present invention is the information terminal according to the 1^{st} aspect of the present invention, wherein the display rule refers to a position directly underneath the detected position or a vicinity of the position directly underneath the detected position.

The 3^{rd} aspect of the present invention is the information terminal according to the 1^{st} aspect of the present invention, wherein the selection rule refers to selecting the screen components based on a genre or a decision history.

The 4^{th} aspect of the present invention the information terminal according to the 1^{st} aspect of the present invention, wherein the sequence refers to an order determined based on a decision history.

The 5^{th} aspect of the present invention is the information terminal according to the 1^{st} aspect of the present invention, wherein when the motion display detecting unit detects that the designating object is separated from the display surface beyond a predetermined distance, the screen component movement rendering unit restores the motion-displayed screen components to respective original states before the motion display of the screen components.

The 6^{th} aspect of the present invention is the information terminal according to the 1^{st} aspect of the present invention, further comprising

a decided position judging unit which, when the motion display detecting unit detects that the designating object enters within a definite distance that is shorter than a predetermined distance, of the display surface, and detects a position of the designating object in a plane parallel to the display surface, judges the screen component displayed at a position on the display surface directly underneath the detected position of the designating object and detects that the judged screen component is decided on by the designating object.

The 7^{th} aspect of the present invention is the information terminal according to the 6^{th} aspect of the present invention, further comprising

a change screen component displaying unit which, when the motion display detecting unit detects that the designating object enters within the predetermined distance of the display surface and detects a position of the designating object in a plane parallel to the display surface, displays a change screen component for changing the motion-displayed screen components to other screen components, at a position directly underneath the detected position of the designating object or in a vicinity of the position directly underneath the detected position of the designating object, wherein

when the decided position judging unit detects that the change screen component is decided on by the designating object, in order to perform the changing, the screen component movement rendering unit restores the motion-displayed screen components to original states before the motion display of the screen components and motion-displays in sequence screen components selected based on a second selection rule that differs from the selection rule, to such positions on the display surface obtained according to a second display rule that differs from the display rule, based on the position of the designating object detected by the motion display detecting unit.

The 8^{th} aspect of the present invention is the information terminal according to the 6^{th} aspect of the present invention, further comprising

an addition screen component displaying unit which, when the motion display detecting unit detects that the designating object enters within the predetermined distance of the display surface and detects a position of the designating object in a plane parallel to the display surface, displays an addition screen component for adding another screen component to the motion-displayed screen components, at a position directly underneath the detected position of the designating object or in a vicinity of the position directly underneath the detected position of the designating object, wherein

when the decided position judging unit detects that the addition screen component is decided on by the designating object, in order to perform the adding, the screen component movement rendering unit does not restore the motion-displayed screen components to original states before the motion display of the screen components and motion-displays in sequence screen components selected based on a second selection rule that differs from the selection rule, to such positions on the display surface obtained according to a second display rule that differs from the display rule, based on the position of the designating object detected by the motion display detecting unit.

The 9^{th} aspect of the present invention is the information terminal according to the 5^{th} aspects of the present inventions, wherein the screen component movement rendering unit restores the motion-displayed screen components in a determined sequence when restoring the motion-displayed screen components to original states before the motion display of the screen components.

The 10^{th} aspect of the present invention is the information terminal according to the 7^{th} aspect of the present invention, wherein when the change screen component is decided on by the designating object, the change screen component displaying unit erases the change screen component.

The 11^{th} aspect of the present invention is the information terminal according to the 8^{th} aspect of the present invention, wherein when the addition screen component is decided on by the designating object, the addition screen component displaying unit erases the addition screen component.

The 12^{th} aspect of the present invention is the information terminal according to the 1^{st} aspect of the present invention, wherein groups of the selected screen components to be motion-displayed at least partially differ from each other according to a position of the designating object detected by the motion display detecting unit.

The 13^{th} aspect of the present invention is the information terminal according to the 1^{st} aspect of the present invention, wherein the motion display detecting unit includes a capacitance panel arranged adjacent to the display surface in order to detect, by a capacitance method, the information related to a distance from the display surface to the designating object that designates the screen components, and the information related to a position of the designating object in a plane parallel to the display surface.

The 14^{th} aspect of the present invention is the information terminal according to the 1^{st} aspect of the present invention, wherein the information related to a distance from the display surface to the designating object designating the screen components, refers that the designating object designating the screen components enters respectively within n-number (where n is a natural number equal to or greater than 1) types of predetermined distances of the display surface.

The 15^{th} aspect of the present invention is a screen component display method comprising:

a display step of displaying a plurality of screen components;

a motion display detecting step of detecting information related to a distance from the display surface to a designating object that designates the screen components, and information related to a position of the designating object in a plane parallel to the display surface; and

a screen component movement rendering step of motion-displaying in sequence the screen components selected according to a selection rule, to such positions on the display surface obtained according to a display rule, based on the information related to the distance and the information related to the position.

The 16^{th} aspect of the present invention is a program embodied on a non-transitory computer-readable medium, the program causing a computer to execute the screen component display method according to the 15^{th} aspect of the present invention.

The 17^{th} aspect of the present invention is the information terminal according to the 7^{th} aspects of the present inventions, wherein the screen component movement rendering unit restores the motion-displayed screen components in a determined sequence also when restoring the motion-displayed screen components to original states before the motion display of the screen components.

According to the present invention, an information terminal and a screen component display method that enable a desired screen component to be easily found and an original state of a screen component prior to movement thereof to be easily discerned can be provided.

### BRIEF DESCRIPTION OF THE DRAWINGS

FIG. 1 is a front configuration diagram of an information terminal according to a first embodiment of the present invention;

FIG. 2(A) is a side configuration diagram of a displaying unit and a contactless input unit according to the first embodiment of the present invention;

FIG. 2(B) is a perspective configuration diagram of the displaying unit and the contactless input unit according to the first embodiment of the present invention;

FIG. 3 is a block diagram of the information terminal according to the first embodiment of the present invention;

FIG. 4 is a control flow diagram of the information terminal according to the first embodiment of the present invention;

FIGS. 5(A) and 5(B) are diagrams illustrating a display surface for describing control by the information terminal according to the first embodiment of the present invention;

FIG. 6 is a diagram schematically illustrating a side view of the displaying unit and the contactless input unit according to the present first embodiment;

FIG. 7(A) is a diagram illustrating a display surface for describing control by the information terminal according to the first embodiment of the present invention;

FIG. 7(B) is a diagram illustrating a display surface for describing control by the information terminal according to the first embodiment of the present invention;

FIG. 7(C) is a diagram illustrating a display surface for describing control by the information terminal according to the first embodiment of the present invention;

FIG. 7(D) is a diagram illustrating a display surface for describing control by the information terminal according to the first embodiment of the present invention;

FIG. 8 is a diagram illustrating a display surface for describing control by the information terminal according to the first embodiment of the present invention;

FIG. 9 is a configuration diagram of the information terminal according to the first embodiment of the present invention as applied to a computer;

FIG. 10 is a diagram illustrating a display surface for describing control by the information terminal according to the first embodiment of the present invention;

FIGS. 11(A) and 11(B) are diagrams illustrating a display surface for describing control by the information terminal according to the first embodiment of the present invention;

FIG. 12(A) is a diagram illustrating a display surface for describing control by the information terminal according to the first embodiment of the present invention;

FIG. 12(B) is a diagram illustrating a display surface for describing control by the information terminal according to the first embodiment of the present invention;

FIG. 12(C) is a diagram illustrating a display surface for describing control by the information terminal according to the first embodiment of the present invention;

FIGS. 13(A) and 13(B) are diagrams illustrating a display surface for describing control by the information terminal according to the first embodiment of the present invention;

FIG. 14 is a front configuration diagram of an information terminal according to a second embodiment of the present invention;

FIGS. 15(A) and 15(B) are diagrams illustrating a display surface for describing control by the information terminal according to the second embodiment of the present invention;

FIG. 16 is a side configuration diagram of a displaying unit and a contactless input unit according to a third embodiment of the present invention;

FIGS. 17(A) and 17(B) are diagrams for describing display positions of icons motion-displayed to a periphery of a change icon according to the third embodiment of the present invention;

FIG. 18(A) is a front view illustrating an arrangement of icons for describing operations of an information terminal according to the third embodiment of the present invention, and FIG. 18(B) is a bottom view of the information terminal according to the third embodiment of the present invention;

FIG. 19(A) is a front view illustrating an arrangement of icons for describing operations of an information terminal according to the third embodiment of the present invention, and FIG. 19(B) is a bottom view of the information terminal according to the third embodiment of the present invention;

FIG. 20(A) is a front view illustrating an arrangement of icons for describing operations of an information terminal according to the third embodiment of the present invention, and FIG. 20(B) is a bottom view of the information terminal according to the third embodiment of the present invention;

FIG. 21(A) is a front view illustrating an arrangement of icons for describing operations of an information terminal according to the third embodiment of the present invention, and FIG. 21(B) is a bottom view of the information terminal according to the third embodiment of the present invention;

FIG. 22(A) is a front view illustrating an arrangement of icons for describing operations of an information terminal according to the third embodiment of the present invention, and FIG. 22(B) is a bottom view of the information terminal according to the third embodiment of the present invention;

FIG. 23(A) is a front view illustrating an arrangement of icons for describing operations of an information terminal according to the third embodiment of the present invention, and FIG. 23(B) is a bottom view of the information terminal according to the third embodiment of the present invention; and

FIG. 24 is a diagram illustrating a display surface of a conventional information terminal.

### DESCRIPTION OF SYMBOLS

10, 40 information terminal
11 displaying unit
12 icon
13 display area
14 detection area
15 contactless input unit
16 detection region
17 motion display region
18 decision region
19 non-detection region
20 first detecting unit
21 second detecting unit
22 icon movement rendering unit
23 change icon displaying unit
24 third detecting unit
25 fourth detecting unit
26 fifth detecting unit
27 decided position judging unit
28 designating unit
30 change icon

### PREFERRED EMBODIMENTS OF THE INVENTION

Hereinafter, preferred embodiments of the present invention will be described in detail with reference to the drawings.

### First Embodiment

An information terminal according to a first embodiment of the present invention will now be described.

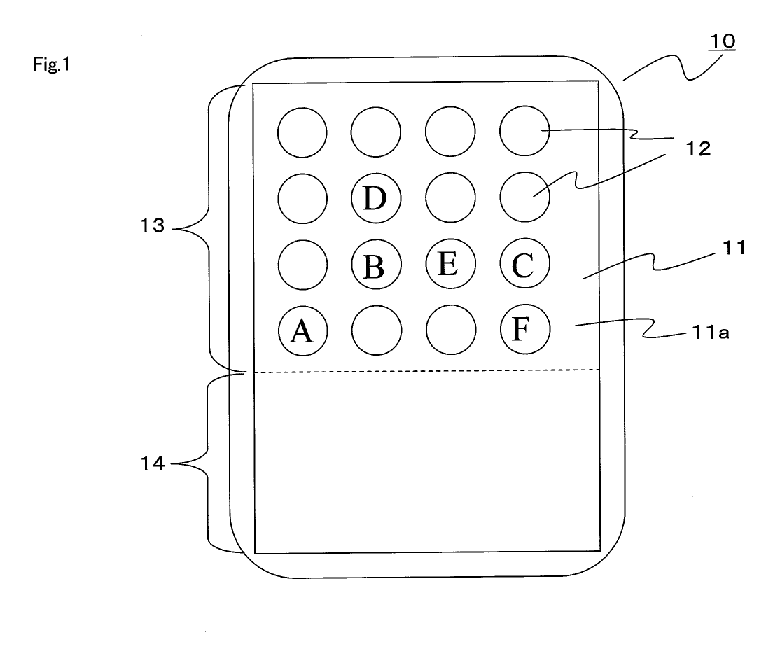

FIG. 1 is a front view of an information terminal according to the first embodiment of the present invention. As illustrated in FIG. 1, an information terminal 10 according to the present first embodiment includes a displaying unit 11, and a plurality of icons 12 that are an example of screen components according to the present invention are displayed on a display surface 11a that is a display surface of the displaying unit 11. The plurality of icons 12 are displayed aligned vertically and horizontally in a display area 13 that is illustrated above the displaying unit 11 in the diagram. In addition, a detection area 14 for detecting an approach by a finger and moving and displaying the icons 12 is provided below the display area 13 in the display surface 11a. A liquid crystal display, an organic EL display, and the like may be used as the displaying unit 11. While the icons 12 are exemplified in the present embodiment, objects to be displayed on a screen such as a thumbnail, a reduced image, a character, or a character string which represent a part of a content will be collectively referred to as screen components, whereby a configuration can be adopted in which screen components appear in the displaying unit 11.

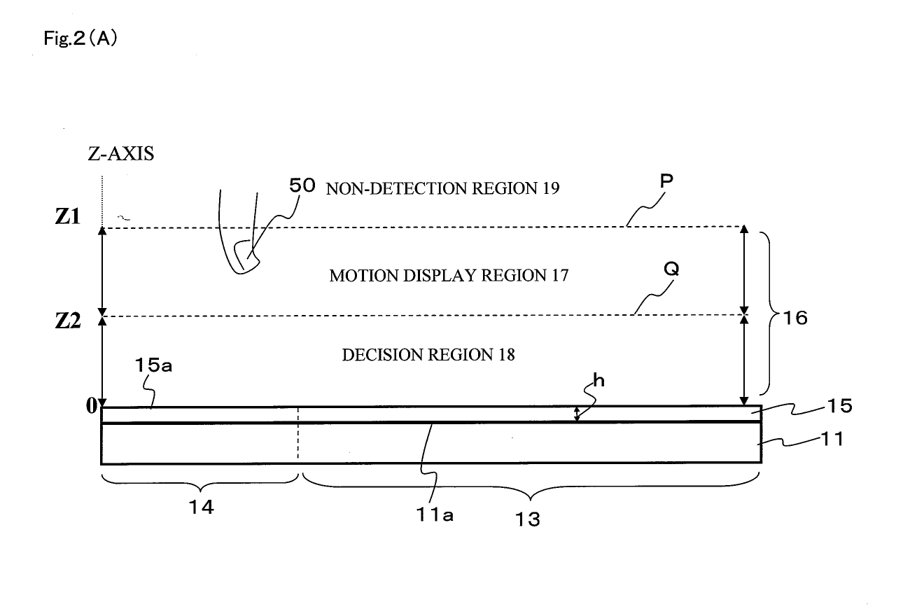

FIG. 2(A) is a side cross-sectional configuration diagram of the displaying unit 11 and a contactless input unit 15 arranged above the displaying unit 11 according to the present first embodiment. In addition, FIG. 2(B) is a perspective configuration diagram of the information terminal 10 according to the present first embodiment. As illustrated in FIG. 2, in the information terminal 10 according to the present first embodiment, the contactless input unit 15 is provided above the displaying unit 11. The contactless input unit 15 enables three-dimensional positional information of a finger 50 to be detected when the finger 50 approaches the display surface 11a. In the present embodiment, a capacitance system is used as the contactless input unit 15.

In addition, as illustrated in FIG. 2(B), vertically upward from a surface 15a of the contactless input unit 15 is assumed to be a positive direction on a z-axis, and considering a corner of the surface 15a as an origin, rightward in FIG. 2(A) is assumed to be a positive direction on a y-axis and frontward in FIG. 2(A) is assumed to be a positive direction on an x-axis.

In the present embodiment, positions more elevated than Z1 from the surface 15a are configured as a non-detection region 19 that is a region in which the finger 50 is not detected even when existing in the region. A region within Z1 from the surface 15a is set as a detection region 16 in which the presence of the finger 50 is detected. The detection region 16 is further divided into two regions, namely, a decision region 18 from the surface 15a to Z2 and a motion display region 17 from Z2 to Z1. A plane parallel to the display surface 11a at Z1 is illustrated by a dotted line as plane P, and a plane parallel to the display surface 11a at Z2 is illustrated by a dotted line as plane Q. While a detailed description will be given later, a penetration of the finger 50 into the decision region 18 from the motion display region 17 means that the finger 50 decide on the icon 12 displayed directly underneath the finger 50.

In the present embodiment, detection points 15b are formed in a matrix state on the contactless input unit 15 on the upper side of the display surface 11a. As the finger 50 approaches, capacitance variation increases at detection points in the vicinity of directly underneath the finger 50. In addition, based on the capacitance variation at a detection point 15b where a maximum variation is detected, a detection is made as to what position (z-axis position) the finger 50 approaches the detection point 15b. In other words, the coming and going of the finger 50 between the non-detection region 19 and the motion display region 17 and between the motion display region 17 and the decision region 18 can be detected. Furthermore, by detecting the detection point 15b whose capacitance variation is maximum, a position (x-y coordinate) of the finger 50 on a plane parallel to the display surface 11a can be detected. In other words, while the finger 50 comes and goes between the non-detection region 19 and the motion display region 17, a position (x-y coordinate) on the plane P that is an interface between the non-detection region 19 and the motion display region 17 can be detected, and while the finger 50 comes and goes between the motion display region 17 and the decision region 18, a position (x-y coordinate) on the plane Q that is an interface between the motion display region 17 and the decision region 18 can be detected. Moreover, an example of a predetermined distance according to the present invention corresponds to a length that is a sum of Z1 and a thickness h (refer to FIG. 2(A)) of the contactless input unit 15 according to the present embodiment, and an example of a definite distance according to the present invention corresponds to a length that is a sum of Z2 and the thickness h of the contactless input unit 15 according to the present embodiment.

Furthermore, while a capacitance method is used to detect a three-dimensional position of the finger 50 in the present embodiment, an infrared system may alternatively be used. In such a case, a three-dimensional position of a finger can be detected by, for example, providing a plurality of infrared irradiating units and light receiving units at an end of the display surface 11a and detecting the blocking of infrared rays by the finger.

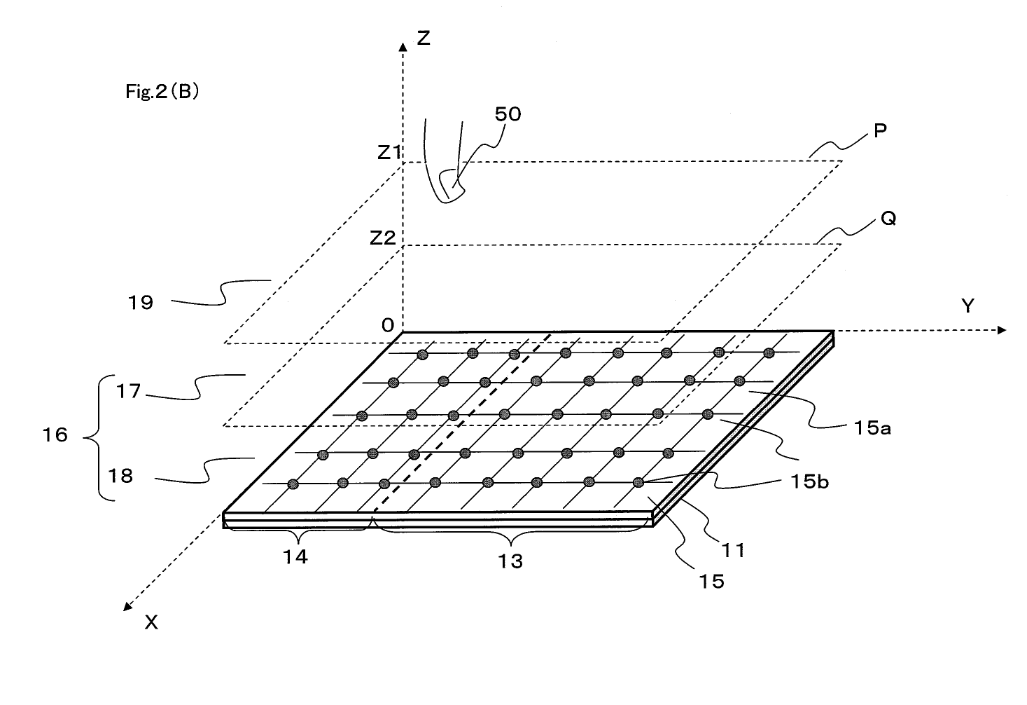

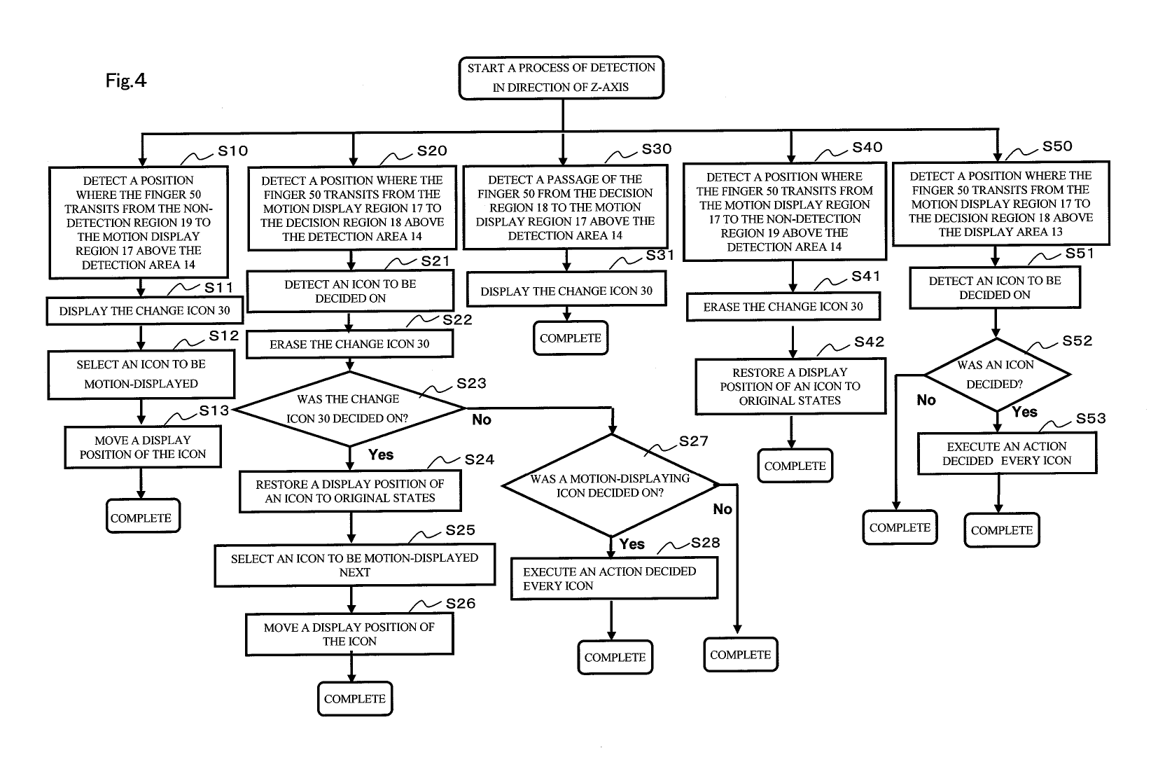

FIG. 3 is a block diagram of the information terminal 10 according to the present first embodiment. As illustrated in FIG. 3, the information terminal 10 according to the present first embodiment is provided with the displaying unit 11 described above, and further includes: a first detecting unit 20 which detects that the finger 50 enters the motion display region 17 that is a space above the display surface 11a of the displaying unit 11; a second detecting unit 21 which detects, when it is detected that the finger 50 enters the motion display region 17, a position of the finger 50 on a plane parallel to the display surface 11a (the plane P in FIG. 2(B)); a moved icon selecting unit 29 which selects based on a preset selection rule, when a position of the finger 50 is detected by the second detecting unit 21, an icon to be motion-displayed; an icon movement rendering unit 22 which causes the selected icon 12 to be motion-displayed in a periphery of a position on the display surface 11a directly underneath the position of the finger 50 detected by the second detecting unit 21; and a change icon displaying unit 23 that cases a change icon 30 (refer to FIG. 5(B) to be described later) for changing the motion-displayed icon 12 to be displayed at the position on the display surface 11a directly underneath the position of the finger 50 detected by the second detecting unit 21.

In addition, also provided are: a third detecting unit 24 which detects that the finger 50 moves from the motion display region 17 to the non-detection region 19 and transmits the detection result to the change icon displaying unit 23 and the icon movement rendering unit 22; and a seventh detecting unit 33 that detects a position (an x-y coordinate position on the plane P) where the finger 50 entered the non-detection region 19. When a movement of the finger 50 to the non-detection region 19 in a space above the detection area 14 is detected by the third detecting unit 24 and the seventh detecting unit 33, the change icon displaying unit 23 erases the change icon 30 and the icon movement rendering unit 22 restores the icon 12 to an original state thereof.

Furthermore, also provided are: a fourth detecting unit 25 which detects that the finger 50 enters the decision region 18 from the motion display region 17; and a fifth detecting unit 26 which detects, when it is detected that the finger 50 enters the decision region 18, a position of the finger 50 on a plane parallel to the display surface 11a (the plane Q in FIG. 2(B)). A detection result to the effect that the finger 50 enters the decision region 18 from the motion display region 17 is transmitted to the change icon displaying unit 23. A decided position judging unit 27 is provided which judges which icon is displayed directly underneath the position of the finger 50 detected by the fifth detecting unit 26 and which assumes that finger 50 decides on the displayed icon 12. A designating unit 28 is provided which, when the decided position judging unit 27 judges that the motion-displayed icon 12 is decided on, performs an action assigned to the icon 12. On the other hand, when the decided position judging unit 27 judges that the change icon 30 is decided on, the judgment is transmitted to the moved icon selecting unit 29 and an icon to be moved based on a different rule is selected. In addition, the moved and collectively displayed icons 12 are restored to their original states by the icon movement rendering unit 22, while the other icons selected based on a selection rule different from the preset selection rule are moved, gathered, and displayed by the moved icon selecting unit 29.

Moreover, provided are: a sixth detecting unit 31 which detects that the finger 50 moves from the decision region 18 to the motion display region 17; and an eighth detecting unit 34 that detects a position (an x-y coordinate position on the plane Q) where the finger 50 entered the motion display region 17. When a movement of the finger 50 to the motion display region 17 in a space above the detection area 14 is detected by the sixth detecting unit 31 and the eighth detecting unit 34, the change icon displaying unit 23 displays the change icon 30 on the display surface 11a.

The contactless input unit 15 illustrated in FIG. 2 is used for the first detecting unit 20, the second detecting unit 21, the third detecting unit 24, the fourth detecting unit 25, the fifth detecting unit 26, the sixth detecting unit 31, the seventh detecting unit 33, and the eighth detecting unit 34 in the block diagram illustrated in FIG. 3. A movement of the finger 50 can be detected due to the fact that variations in the three-dimensional position of the finger 50 can be detected per predetermined period of time by sampling a capacitance obtained from the contactless input units 15 at predetermined intervals.

In other words, the first detecting unit 20, the second detecting unit 21, the third detecting unit 24, the fourth detecting unit 25, the fifth detecting unit 26, the sixth detecting unit 31, the seventh detecting unit 33, and the eighth detecting unit 34 respectively include the contactless input unit 15 and a computing unit that computes a three-dimensional position of the finger from a capacitance value obtained from the contactless input unit 15.

In addition, an example of a motion display detecting unit according to the present invention corresponds to the first detecting unit 20, the second detecting unit 21, the third detecting unit 24, the fourth detecting unit 25, and the fifth detecting unit 26 according to the present embodiment.

Furthermore, an example of a screen component movement rendering unit according to the present invention corresponds to the icon movement rendering unit 22 according to the present embodiment. An example of a change screen component displaying unit according to the present invention corresponds to the change icon displaying unit 23 according to the present embodiment.

Next, operations performed by the information terminal 10 according to the present first embodiment will be described together with an example of the screen component display method according to the present invention.

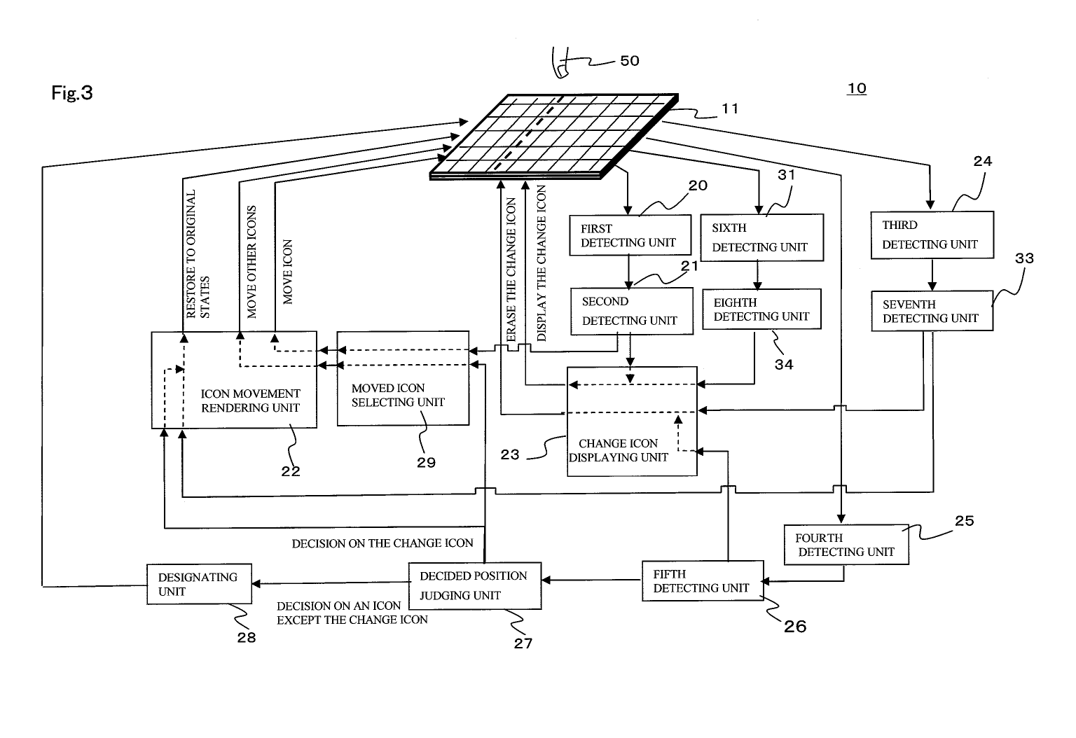

FIG. 4 is a flow diagram of a control of the information terminal 10 according to the present first embodiment. For example, by turning on power (not illustrated) of the information terminal 10, a plurality of icons 12 aligned as illustrated in FIG. 1 is displayed on the display surface 11a. A step for displaying the icons 12 in this manner corresponds to an example of a display step according to the present invention. Moreover, in the following description, the respective positions of the icons 12 in the state illustrated in FIG. 1 will also be referred to as initial positions.

At the same time the icons 12 are displayed, detection of the finger 50 in a space perpendicular to the display surface 11a (the z-axis direction illustrated in FIG. 2) is started. While the detection is performed by the contactless input unit 15 described above, when using a capacitance method, an approach or a departure of the finger 50 can be detected as described above by sampling capacitance at a regular sampling period.

First, a case will be described in which the finger 50 moves in the space above the detection area 14 of the display surface 11a from the non-detection region 19 to the motion display region 17.

In S10, when the first detecting unit 20 detects that the finger 50 enters the motion display region 17 from the non-detection region 19 in the space above the detection area 14 of the display surface 11a, the second detecting unit 21 detects a position where the finger 50 entered the motion display region 17 (an x-y coordinate position of the finger 50 passing through the plane P). The detection by the second detecting unit 21 doubles as a detection of a movement of the finger 50 at a position on the detection area 14. Moreover, in the present embodiment, the contactless input unit 15 employing a capacitance method simultaneously detects that the finger 50 enters the motion display region 17 from the non-detection region 19 and an x-y coordinate position on the plane P upon entry of the finger 50 to the motion display region 17.

Specifically, it is recognized that the finger 50 moves from the non-detection region 19 to the motion display region 17 when a position of the finger 50 is not detected at a given sampling time and the finger 50 is detected at a position in the motion display region 17 at a next sampling time. Furthermore, the position in the motion display region 17 where the finger 50 is detected at this point can be assumed to be the x-y coordinate position on the plane P of the finger 50 upon entry to the motion display region 17.

In addition, an example of a motion display detecting step according to the present invention corresponds to the detection by the first detecting unit 20 of the finger 50 entering the motion display region 17 from the non-detection region 19 in the space above the detection area 14 of the display surface 11a and the detection by the second detecting unit 21 of the position where the finger 50 entered the motion display region 17 (the x-y coordinate position of the finger 50 passing through the plane P).

Next, in S11, the change icon displaying unit 23 displays the change icon 30 at a position on the display surface 11a directly underneath the position where the finger 50 entered the motion display region 17. FIG. 5(A) is a diagram illustrating a display state of an icon on the display surface 11a in a state where the finger 50 is not detected by the contactless input unit 15. In addition, FIG. 5(B) is a diagram illustrating a display state of icons on the display surface 11a upon the entry of the finger 50 to the motion display region 17 from the non-detection region 19. As illustrated in FIGS. 5(A) and 5(B), the change icon 30 is displayed at a position on the display surface 11a directly underneath the finger 50 having entered the motion display region 17. It should be noted that, as illustrated in FIG. 5(A), icons 12A, 12B, 12C, 12D, 12E, and 12F are respectively illustrated in abbreviated form as A, B, C, D, E, and F, and will be similarly illustrated in abbreviated form in the subsequent drawings.

Next, in S12, as illustrated in FIG. 5(B), based on a predetermined selection rule set in advance, an icon 12 to be motion-displayed is selected from the icons existing on the information terminal 10 by the moved icon selecting unit 29. As the predetermined selection rule set in advance, a reverse chronological order of decision history, a descending order of the number of decisions made, an order of registrations in “favorites” of Internet Explorer or the like, an association-based order according to application genre (game, player, net application), and the like may be adopted. In FIG. 5(B), the icons 12A, 12B, and 12C are selected.

Next, in S13, the selected icons 12A, 12B, and 12C are motion-displayed and gathered one by one at staggered timings by the icon movement rendering unit 22 to predetermined positions in the periphery of the change icon 30 and control is completed.

In this case, motion display refers to having a user visualize that an icon is moving by displaying the icon at slightly moved positions from a display position before movement to a display position after movement.

A predetermined position in the periphery of the change icon 30 corresponds to an example of a position on a display surface obtained by a display rule according to the present invention. Moreover, S12 and S13 correspond to an example of a screen component movement rendering step according to the present invention.

In FIG. 5(B) and similarly in subsequent drawings, initial positions before motion display are indicated by the dotted lines. In addition, the icons 12A, 12B, and 12C are displayed on a substantially concentric circle at a distance n from the change icon 30. In FIG. 5(B), a movement order of the icons 12A, 12B, and 12C is indicated by the numerals 1, 2, and 3. As the movement order, for example, an order of playback history, a descending order of number of playbacks, a descending order of evaluation results, or an order of registration to favorites may be adopted. Moreover, in the present embodiment, while an icon to be motion-displayed is selected from icons existing on the information terminal based on a selection rule set in advance, the icon to be motion-displayed itself may alternatively be decided in advance. In other words, instead of using a selection rule, an icon to be motion-displayed may be decided in advance.

Next, a case will be described in which the finger 50 moves in the space above the detection area 14 of the display surface 11a from the motion display region 17 to the decision region 18.

In S20, a transit of the finger 50 from the motion display region 17 to the decision region 18 is detected by the fourth detecting unit 25, and a position where the finger enters the decision region 18 from the motion display region 17 (an x-y coordinate position of the finger 50 passing through the plane Q) is detected by the fifth detecting unit 26. The detection by the fifth detecting unit 26 doubles as a detection of a movement of the finger 50 at a position above the detection area 14. Moreover, in the present embodiment, the contactless input unit 15 employing a capacitance method simultaneously detects a transit of the finger 50 from the motion display region 17 to the decision region 18 and an x-y coordinate position on the plane Q upon entry of the finger 50 to the decision region 18.

Specifically, it is recognized that the finger 50 moves from the motion display region 17 to the decision region 18 when a position of the finger 50 is detected at a given sampling time in the motion display region 17 and a position of the finger 50 is detected in the decision region 18 at a next sampling time. In addition, the position where the finger 50 is detected in the decision region 18 at this point can be assumed to be the position where the finger entered the decision region 18 (the x-y coordinate position of the finger 50 passing through the plane Q). Alternatively, the position of the finger 50 last detected in the motion display region 17 may be considered to be the position where the finger entered the decision region 18, or an intersection point of a line connecting the position of the finger 50 in the motion display region 17 and the position of the finger 50 in the decision region 18 at the two sampling times described above with the plane Q may be considered to be the position where the finger entered the decision region 18.

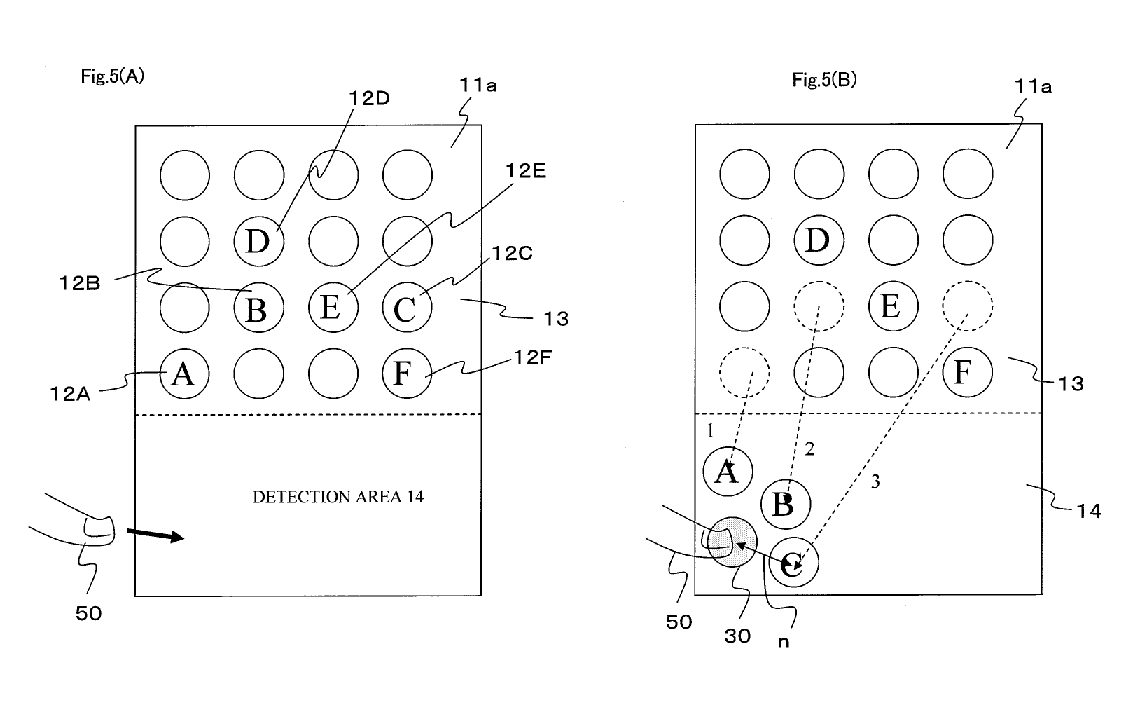

Next, in S21, the decided position judging unit 27 judges which icon is displayed directly underneath the position of the finger 50 detected by the fifth detecting unit 26, and assumes that the finger 50 decides on the displayed icon 12. FIG. 6 is a diagram schematically illustrating a side view of the displaying unit 11 and the contactless input unit 15 according to the present first embodiment. FIG. 6 illustrates the icons 12A, 12B, 12C and the change icon 30 illustrated in FIG. 5(B). While the icons 12A, 12B, 12C and the change icon 30 are arranged in a straight line in FIG. 6 unlike in FIG. 5(B), such an arrangement is for descriptive purposes only. In addition, in FIG. 6, no distinction is made between the detection area 14 and the display area 13. For example, when the finger transits from the motion display region 17 to the decision region 18 at a position such as that indicated by the finger 50′ in FIG. 6, the icon 12A displayed directly underneath the finger 50′ is assumed to be decided on. In addition, when the finger transits from the motion display region 17 to the decision region 18 at a position indicated by the finger 50″, the change icon 30 displayed directly underneath the finger 50″ is assumed to be decided on.

Next, in S22, the change icon 30 is erased by the change icon displaying unit 23.

In addition, in S23, a judgment is made on whether or not the change icon 30 is decided on in S21 above, and if the change icon 30 is decided on, control proceeds to S24. If the change icon 30 is not decided on, control proceeds to S27.

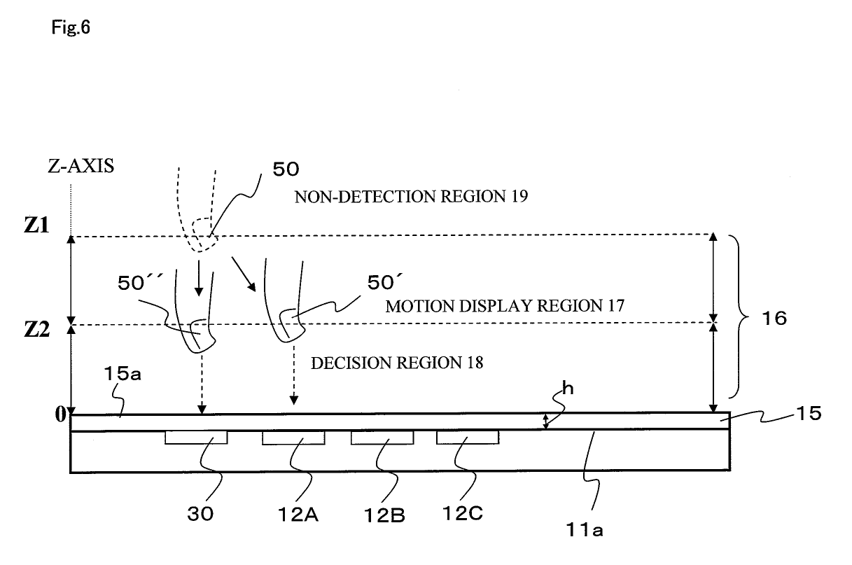

If the change icon 30 is decided on, in S24, the motion-displayed icons 12A, 12B, and 12C are restored to their original states (the initial states illustrated in FIG. 1) by the icon movement rendering unit 22. FIG. 7(A) is a diagram illustrating a display state of an icon on the display surface 11a in a state where the change icon 30 is decided on. As illustrated in FIG. 7(A), the change icon 30 is erased and the motion-displayed icons 12C, 12B, and 12A are returned to their original states in a sequence of the numerals indicated in the drawing.

Subsequently, in S25, an icon 12 to be motion-displayed next is selected by the moved icon selecting unit 29 based on a selection rule that differs from the initially-used selection rule. For example, the initially-used selection rule is set such as adopting a descending order of number of decisions made for an icon to be motion displayed first, and different rules can be set in advance such as adopting a reverse chronological order of decision history for an icon to be motion-displayed next. Alternatively, an icon related to a music genre may be selected as the icon to be motion-displayed first and an icon related to a movie genre may be selected as the icon to be motion-displayed next. As shown, various contents are conceivable as contents of a switchover of icons when the change icon 30 is decided on, including a switchover of history types, a switchover of genres, a switchover of artists, a switchover of albums, and a switchover of playlists. Moreover, an example of the selection rule according to the present invention corresponds to the initially-used selection rule according to the present embodiment, and an example of a second selection rule according to the present invention corresponds to the selection rule that differs from the initially-used selection rule according to the present embodiment.

In addition, a predetermined position in the periphery of the change icon 30 such as that illustrated in FIG. 7(B) corresponds to an example of a position on the display surface obtained by a second display rule according to the present invention.

Next, in S26, as illustrated in FIG. 7(B), the icons 12D, 12E, and 12F selected in S25 are motion-displayed and gathered in sequence by the icon movement rendering unit 22 in the periphery of the position where the change icon 30 is displayed.

On the other hand, when it is judged in S23 that the change icon 30 is not decided on, in S27, a judgment is made on whether or not the motion-displayed icons 12A, 12B, or 12C is decided on.

Subsequently, when it is judged in S27 that an icon among the motion-displayed icons 12A, 12B, and 12C is decided on, an application assigned per icon is activated by the designating unit 28 in S28. For example, when the decided icon is an icon related to a game, the game is activated, and in case of an icon related to music, an application for reproducing a music file is activated and music is reproduced.

In addition, when it is judged in S27 that the motion-displayed icons 12A, 12B, or 12C is not decided on, the control is completed.

Next, a case will be described in which the finger 50 moves in the space above the detection area 14 of the display surface 11a from the decision region 18 to the motion display region 17.

When the finger 50 exists in the decision region 18 above the detection area 14, the change icon 30 is erased from the screen by the control of S22. In this state, in S30, a transit of the finger 50 from the decision region 18 to the motion display region 17 is detected by the sixth detecting unit 31, and a position where the finger 50 enters the motion display region 17 (an x-y coordinate position of the finger 50 passing through the plane Q) is detected by the eighth detecting unit 34. The x-y coordinate is detected by the eighth detecting unit 34 and indicates whether a movement of the finger 50 occurred in the space above the detection area 14. Moreover, in the present embodiment, the contactless input unit 15 employing a capacitance method simultaneously detects that the finger 50 enters the motion display region 17 from the decision region 18 and an x-y coordinate position on the plane Q upon entry of the finger 50 to the motion display region 17.

Specifically, it is recognized that the finger 50 moves from the decision region 18 to the motion display region 17 when a position of the finger 50 is detected at a given sampling time in the decision region 18 and a position of the finger 50 is detected in the motion display region 17 at a next sampling time. In addition, the position of the finger 50 detected in the motion display region 17 at this point can be assumed to be the position where the finger entered the motion display region (the x-y coordinate position of the finger 50 passing through the plane Q). Alternatively, the position of the finger 50 last detected in the decision region 18 may be considered to be the position where the finger entered the motion display region 17, or an intersection point of a line connecting the position of the finger 50 in the motion display region 17 and the position of the finger 50 in the decision region 18 at the two sampling times described above with the plane Q may be considered to be the position where the finger entered the decision region 18.

Subsequently, in S31, the change icon 30 is once again displayed at the originally-displayed position by the change icon displaying unit 23 and the control is completed.

Moreover, as illustrated in FIG. 7(B), when, after motion display of the icons 12D, 12E, and 12F, the transit of the finger 50 from the decision region 18 to the motion display region 17 in the space above the detection area 14 is detected by the sixth detecting unit 31 and the eighth detecting unit 34, the change icon 30 is displayed as illustrated in FIG. 7(C). Subsequently, by moving the finger 50 from the motion display region 17 to the decision region 18 as described earlier, any of the change icon 30 and the icons 12D, 12E, and 12F can be decided on. FIG. 7(D) illustrates a state where the icon 12D is decided on.

Next, a case will be described in which the finger 50 moves in the space above the detection area 14 of the display surface 11a from the motion display region 17 to the non-detection region 19.

When the finger 50 exists in the motion display region 17 above the detection area 14, the change icon 30 is displayed on the screen by S11 and S31. In this state, in S40, a transit of the finger 50 from the motion display region 17 to the non-detection region 19 in the space above the detection area 14 is detected by the third detecting unit 24, and a position where the finger 50 enters the non-detection region 19 (an x-y coordinate position of the finger 50 passing through the plane P) is detected by the seventh detecting unit 33. The x-y coordinate of the finger 50 is detected by the seventh detecting unit 33 and indicates whether a movement of the finger 50 occurred in the space above the detection area 14. Moreover, in the present embodiment, the contactless input unit 15 employing a capacitance method simultaneously detects that the finger 50 enters the non-detection region 19 from the motion display region 17 and an x-y coordinate position on the plane P upon entry of the finger 50 to the non-detection region 19.

Specifically, it is recognized that the finger 50 moves from the motion display region 17 to the non-detection region 19 when a position of the finger 50 is detected at a given sampling time at a position in the motion display region 17 and a position of the finger 50 is not detected at a next sampling time. Furthermore, the position in the motion display region 17 where the finger 50 is detected at this point can be assumed to be the x-y coordinate position on the plane P of the finger 50 upon entry to the non-detection region 19.

Subsequently, in S41, the change icon displaying unit 23 erases the change icon 30.

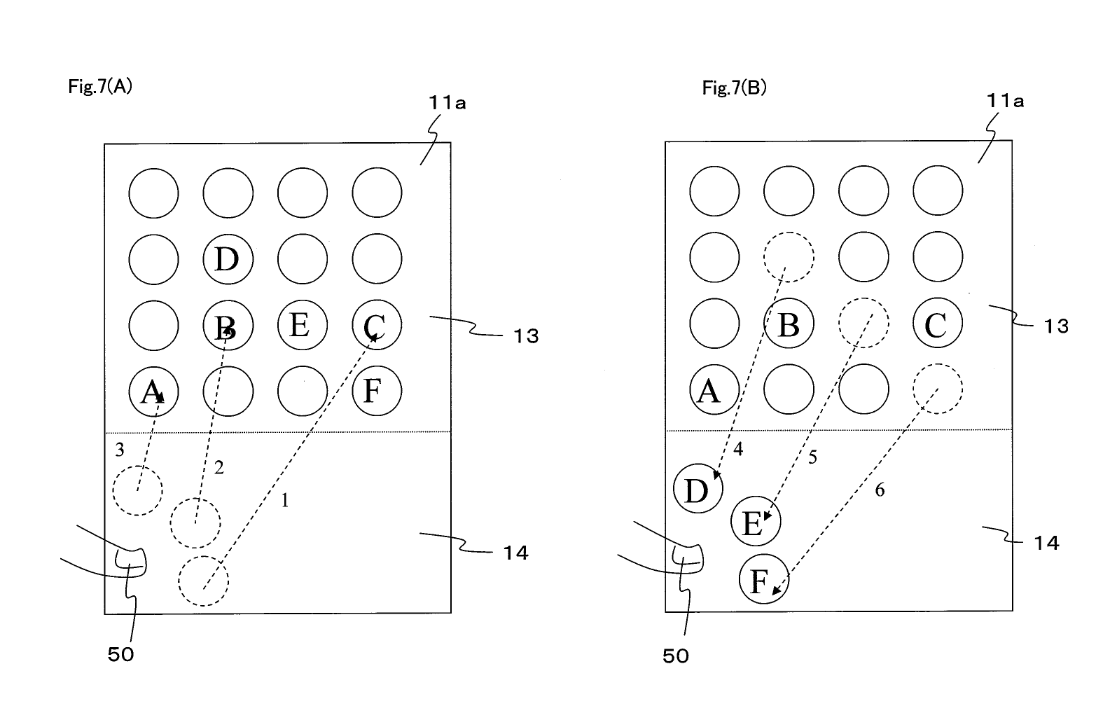

Then, as illustrated in FIG. 8, in S42, the motion-displayed icons 12A, 12B, and 12C are returned to their original states in a sequence of 12C, 12B, and 12A (a numerical order of 1, 2, and 3 illustrated in FIG. 8) by the icon movement rendering unit 22, and control is completed.

Next, a case will be described in which the finger 50 moves in the space above the display area 13 of the display surface 11a from the motion display region 17 to the decision region 18.

In S50, when a transit of the finger 50 from the motion display region 17 to the decision region 18 is detected by the fourth detecting unit 25, a position where the finger 50 transited from the motion display region 17 to the decision region 18 is detected by the fifth detecting unit 26. The x-y coordinate of the finger 50 is detected by the fifth detecting unit 26 and indicates whether a movement of the finger 50 occurred in the space above the display area 13.

Next, in S51, the decided position judging unit 27 judges which icon is displayed directly underneath the position of the finger 50 detected by the fifth detecting unit 26, and assumes that the finger decided on the displayed icon 12.

Subsequently, when it is judged in S52 that any of the icons 12 not motion-displayed as illustrated in FIG. 1 is decided on, an application assigned per icon is activated by the designating unit 28 in S53 and the control is completed.

Control is also completed when it is conversely not judged that any of the icons is decided on.

As described, in the present embodiment, since only selected icons among a plurality of icons existing on the information terminal are moved to and displayed in a vicinity of a finger, a desired icon is easy to find even if a large number of icons exist on the information terminal.

In addition, in the present embodiment, since icons 12 to be motion-displayed are motion-displayed and gathered one by one, a user can identify original states of the icons. Therefore, since the user is able to learn the original states of the icons, when a finger is brought close to the display area 13 to directly decide on a desired icon 12, the icon 12 can now be promptly decided on without having to locate the position of the icon 12.

Furthermore, in the present embodiment, even when restoring the icons 12 to their original states, a user can further learn the original positions of the icons by restoring one icon at a time.

Moreover, in the present embodiment, when the finger 50 moves from the decision region 18 to the motion display region 17, by erasing the change icon 30 as described in S22, the user can be reminded that the finger 50 exists in the decision region 18. Therefore, when deciding on either the change icon 30 or a motion-displayed icon 12, the user can be reminded that the finger must be moved to the motion display region 17. In addition, when the finger 50 is moved from the decision region 18 to the motion display region 17, by displaying the change icon 30 as described in S31, the user can be reminded that the finger 50 exists in the motion display region 17.

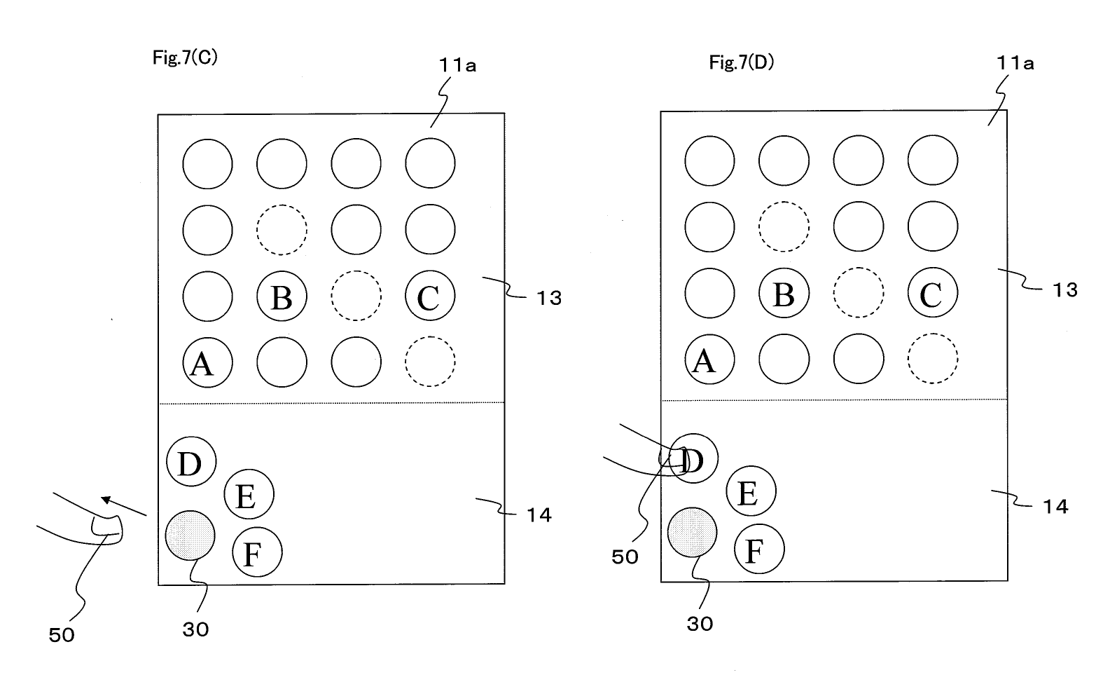

The configuration described above can be realized as an example by a computer, for example, it can be realized as a configuration of an information terminal such as that illustrated in FIG. 9.

The information terminal illustrated in FIG. 9 includes an output device 41, an input device 42, a video processing unit 43, a CPU processing unit 44, and a memory 45. Although the contactless input unit 15 described above is to be used as the input device 42, a power switch and a contact input unit such as a touch sensor, a key, and a trackball may be additionally provided. The displaying unit 11 described above is used as the output device 41, and an audio output unit 412 that performs volume changes, sets equalizer settings, and outputs audio is further provided. Examples of the audio output unit 412 include a DAC and an amplifier, a speaker, and a headphone. The video processing unit 43 includes a decoding unit 431 for decoding compressed audio and video data and a render processing unit 432 for displaying and moving icons and performing rotation, enlargement, reduction, and the like of decoded video. The icon movement rendering unit 22 and the change icon displaying unit 23 described above are included in the render processing unit 432. The CPU processing unit 44 includes the decided position judging unit 27, the designating unit 28, and the moved icon selecting unit 29 described above. The memory 45 includes a volatile region and a nonvolatile region. Specifically, the memory 45 is constituted by a volatile memory such as a DRAM (Dynamic Random Access Memory), a nonvolatile memory such as a flash memory, a hard disk device, and the like. The memory 45 includes a plurality of applications 451 related to a plurality of icons and contents 452 such as music, video, and photographs.

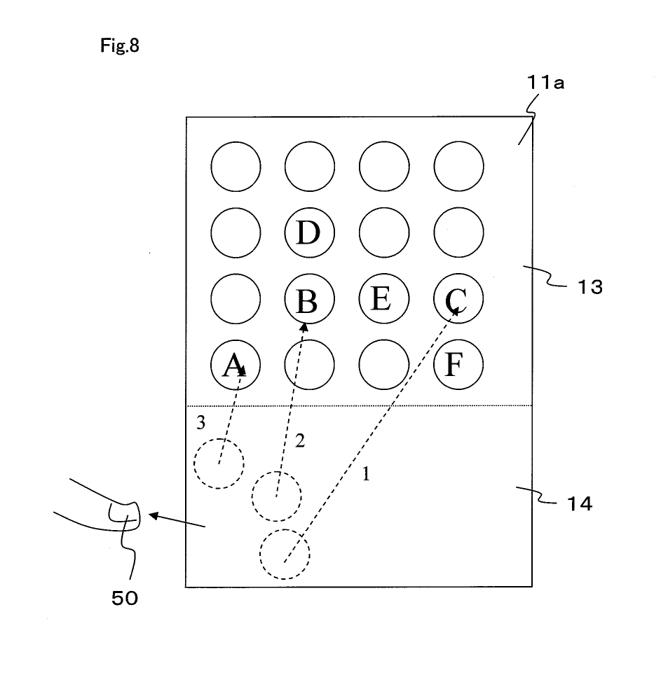

Moreover, in the present embodiment, when a finger moves in a space above the detection area 14 from the non-detection region 19 to the motion display region 17, only the icons 12A, 12B, and 12C are motion-displayed to the periphery of the change icon 30 as illustrated in FIG. 5(B). However, as illustrated in FIG. 10, in addition to the motion-displayed icons 12A, 12B, and 12C selected according to a predetermined selection rule set in advance, the icons 12D, 12E, and 12F selected according to a predetermined selection rule that differs from the predetermined selection rule above may also be motion-displayed. In doing so, the motion display may be performed according to a rule of descending priority and according to a descending order of priorities of the icons. In the case illustrated in FIG. 10, the icons 12A, 12B, 12C, 12D, 12E, and 12F are motion-displayed in a sequence of the numerals 1, 2, 3, 4, 5, and 6 illustrated in the drawing.

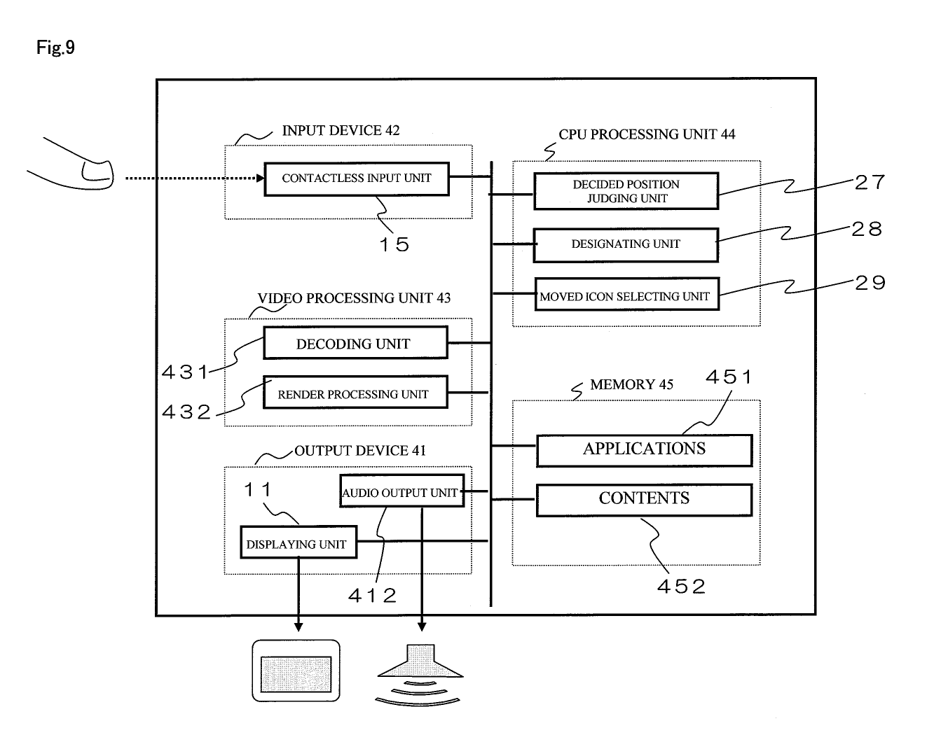

In addition, an example of a change screen component according to the present invention corresponds to the change icon 30 according to the present embodiment, and an example of a change screen component displaying unit according to the present invention corresponds to the change icon displaying unit 23 according to the present embodiment. In the present embodiment, the change icon 30 is shown which restores a motion-displayed icon selected according to a predetermined selection rule to an original state thereof and motion-displays an icon selected according to other predetermined selection rule (an icon of a different type). However, without restoring the motion-displayed icon to the original state, an icon of a different type may additionally be motion-displayed to the periphery of the motion-displayed icon. Specifically, when a finger moves from the non-detection region 19 to the motion display region 17, only the icons 12A, 12B, and 12C are motion-displayed to the periphery of an addition icon 32 as illustrated in FIG. 11(A) by an addition icon displaying unit provided in place of the change icon displaying unit 23, and by deciding on the addition icon 32, the addition icon 32 is erased and the icons 12D, 12E, and 12F of different types are motion-displayed to the periphery of the icons 12A, 12B, and 12C as illustrated in FIG. 11(B). Moreover, an example of an addition screen component displaying unit according to the present invention corresponds to the addition icon displaying unit according to the present embodiment and an example of addition screen components according to the present invention corresponds to the addition icon 32 according to the present embodiment. In addition, the positions of the icons 12D, 12E, and 12F of different types in the periphery of the icons 12A, 12B, and 12C correspond to an example of positions on a display screen obtained according to a second display rule of the present invention.

Furthermore, while three icons 12 (icons 12A, 12B, and 12C) are selected according to a single predetermined selection rule in FIG. 5(B), when there is a large number of icons 12 selected according to a single predetermined selection rule such as a case of six (when the icons 12A, 12B, 12C, 12D, 12E, and 12F are decided on), the icons 12D, 12E, and 12F may be arranged so as to be further motion-displayed in the periphery of the icons 12A, 12B, and 12C.

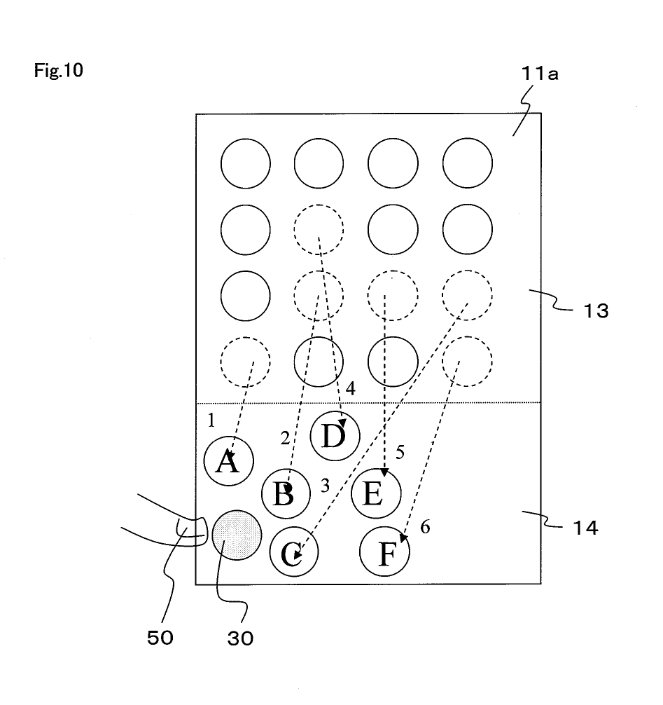

Moreover, in the above description, while a position of the icon 12 to be motion-displayed is displayed on the display surface 11a before movement, an icon which is not displayed on the display surface 11a and which is displayed by scrolling the screen may be arranged so as to move to the periphery of the change icon 30. For example, supposing that the icon 12C among the selected icons 12A, 12B, and 12C is not displayed on the display surface 11a, as illustrated in FIG. 12(A), the icons 12A and 12B are first motion-displayed in sequence to the periphery of the change icon 30. Next, as illustrated in FIG. 12(B), the screen is scrolled so that the icon 12C is displayed on the display surface 11a (refer to the arrow S). After the icon 12C is displayed on the display surface 11a, as illustrated in FIG. 12(C), the icon 12C is motion-displayed to the periphery of the change icon 30.

As shown, by first scrolling to cause the icon 12C to be displayed and then motion-displaying the icon 12C, even when an icon is not displayed on the display surface 11a, the user is able to learn an original state of the icon.

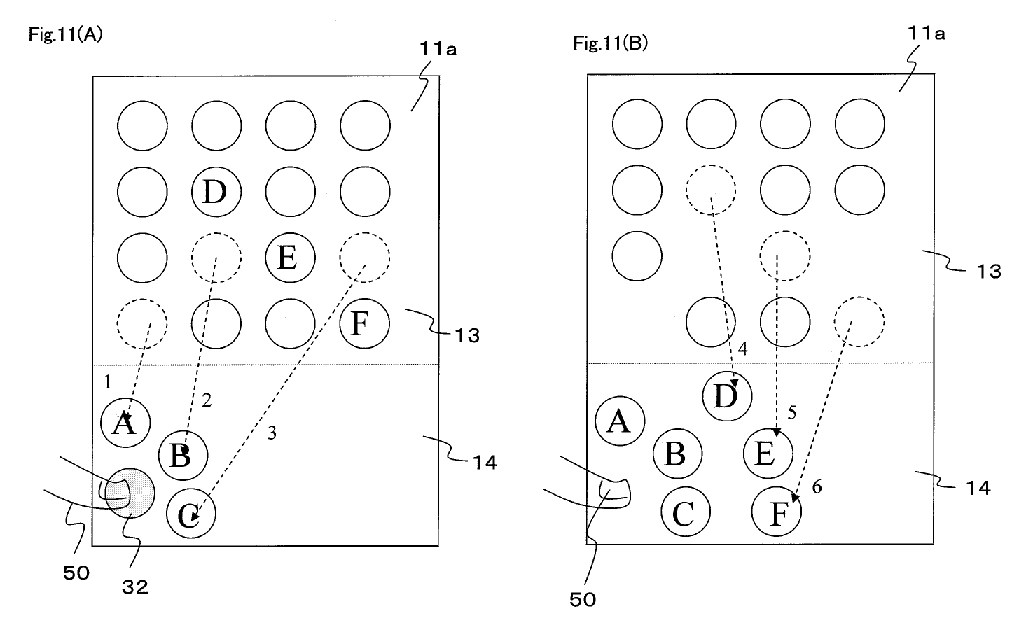

In addition, icon display need not be limited to that illustrated in FIG. 1 and a plurality of icons 12 may be displayed in an alignment such as that illustrated in FIG. 13(A). In FIG. 13(A), icons 12A, 12B, 12C, 12D, 12E, and 12F of jacket images of music albums are displayed in a vertical line, and the titles, performers, and the like of the respective music albums are displayed on the right-hand side of the icons. In such a configuration, when a finger moves from the non-detection region 19 to the motion display region 17 in a space above the detection area 14 arranged below the display surface 11a, as illustrated in FIG. 13(B), the change icon 30 is displayed directly underneath the finger, and icons 12B, 12E, and 12D selected based on a preset selection rule (for example, in an order of new songs) are motion-displayed in a single row above the change icon 30. Furthermore, in the embodiment described above, while the icons 12A, 12B, and 12C to be motion-displayed are displayed at positions at a distance n from the center of the change icon 30 in FIG. 5(B), the distances need not be the same as illustrated in FIG. 13(B) and a distance from the change icon 30 may be varied for each icon 12.

### Second Embodiment

Next, an information terminal according to a second embodiment of the present invention will now be described.

While the information terminal according to the present second embodiment is basically configured the same as that according to the first embodiment, the information terminal according to the present second embodiment differs in that a detection area is divided into a left side and a right side. Therefore, a description will be given focusing on this difference. Moreover, like components to the first embodiment are designated by like reference characters.

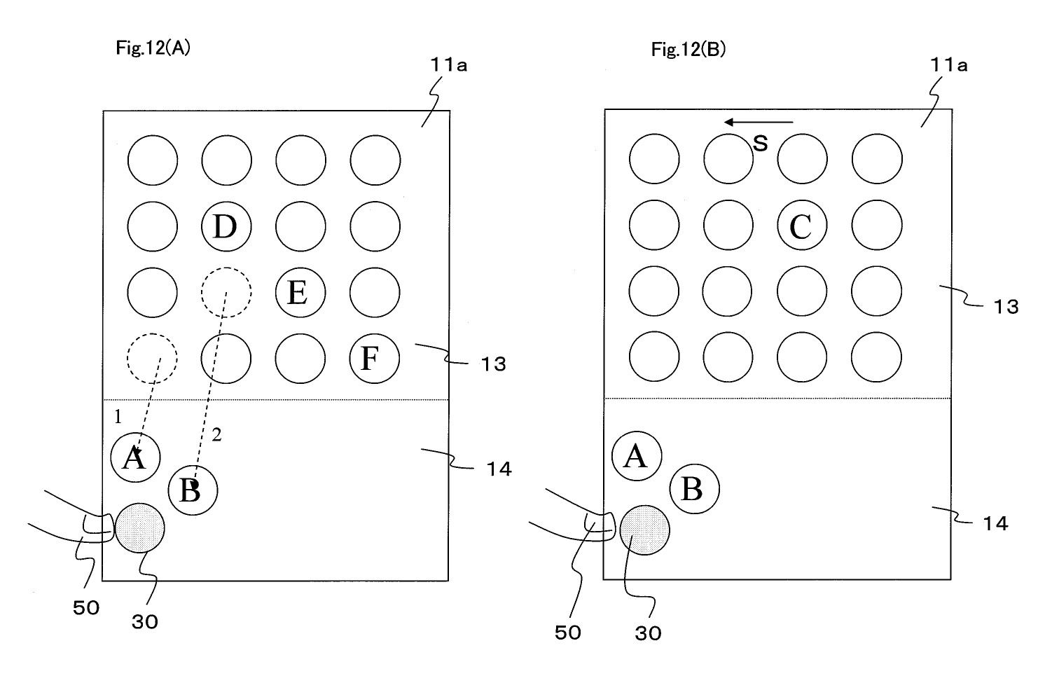

FIG. 14 is a front view of an information terminal 40 according to the present second embodiment. As illustrated in FIG. 14, in the information terminal 40 according to the present second embodiment, a detection area 14 is divided into a first detection area 14a on the left-hand side in the drawing and a second detection area 14b on the right-hand side in the drawing.

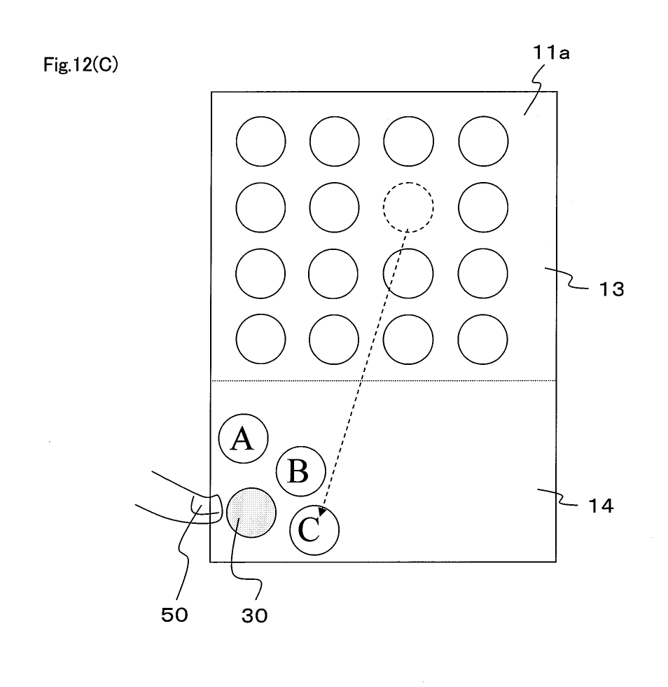

With the information terminal 40 according to the present second embodiment, when a finger 50 moves from a non-detection region 19 to a motion display region 17 in a space above the first detection area 14a, a change icon 30 is displayed as illustrated in FIG. 15(A) and icons 12A, 12B, and 12C selected based on a predetermined selection rule set in advance are motion-displayed one by one to a periphery of the change icon 30.

On the other hand, when the finger 50 moves from the non-detection region 19 to the motion display region 17 in a space above the second detection area 14b, a change icon 30 is displayed as illustrated in FIG. 15(B) and icons 12D, 12E, and 12F selected based on a different selection rule as that described above are motion-displayed to the periphery of the change icon 30. By deciding on the change icon 30, the motion-displayed icons are restored to their original states and icons selected based on a different rule are motion-displayed.

As described above, in the present second embodiment, by dividing the detection area 14 into the first detection area 14a and the second detection area 14b, a desired icon can be found more quickly by adopting a setting where, for example, a detection in the first detection area 14a causes an icon related to a game to be motion-displayed and a detection in the second detection area 14b causes an icon related to a net application to be motion-displayed.

Moreover, while groups of icons to be motion-displayed are completely different between the first detection area 14a and the second detection area 14b in the present second embodiment, a portion of the groups of icons may be overlapped. An example of a group of screen components according to the present invention corresponds to the icons 12A, 12B, and 12C or the icons 12D, 12E, and 12F.

### Third Embodiment

Next, an information terminal according to a third embodiment of the present invention will now be described.

While the information terminal according to the present third embodiment is basically configured the same as that according to the first embodiment, the information terminal according to the present third embodiment differs in that a motion display region 17 is divided in plurality in a direction parallel to a displaying unit 11 and that control is performed such that when a finger 50 approaches the displaying unit 11, a selected icon gradually approaches the finger 50. Therefore, a description will be given focusing on this difference.

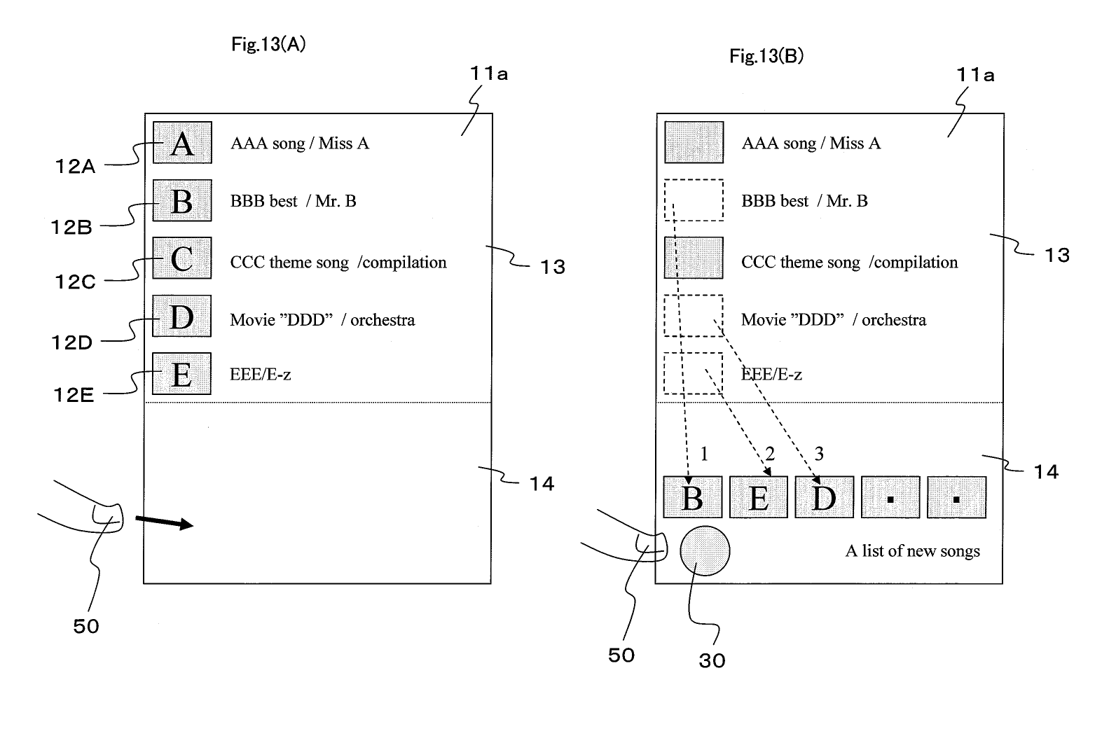

FIG. 16 is a side cross-sectional configuration diagram of the displaying unit 11 and a contactless input unit 15 arranged above the displaying unit 11 according to the present third embodiment. As illustrated in FIG. 16, in an information terminal 60 according to the present third embodiment, the motion display region 17 is divided into n-number (where n is a natural number equal to or greater than 1) of regions in a direction parallel to the displaying unit 11. Z1 and P as described in the first embodiment are now respectively denoted as Z1₁ and P₁, points Z1₂ to Z1ₙ are provided between Z1₁ and Z2, and planes parallel to a display surface 11a at the respective points are illustrated by dotted lines as planes P₁ to Pₙ. In addition, regions between each of the planes P₁ to Pₙ are to be denoted as motion display regions 17₁ to 17ₙ.

Next, detection in a case where the finger 50 approaches the display surface 11a will be described.

A first detecting unit 20 detects that the finger 50 enters any motion display region 17ₖ of the motion display regions 17₁ to 17ₙ from a non-detection region 19, and a second detecting unit 21 detects a position on a plane Pₖ on an upper side of the motion display region 17ₖ (where 1≦k≦n, k is a natural number) entered by the finger 50 where the finger 50 entered the motion display region 17ₖ. Specifically, it is recognized that the finger 50 moves from the non-detection region 19 to any motion display region 17ₖ of the motion display regions 17₁ to 17ₙ when a position of the finger 50 is not detected at a given sampling time and the finger 50 is detected at a position in the motion display region 17ₖ at a next sampling time. Furthermore, the position in the motion display region 17ₖ where the finger 50 is detected at this point can be assumed to be an x-y coordinate position on the plane Pₖ of the finger 50 upon entry to the motion display region 17ₖ.

In addition, the first detecting unit 20 detects that the finger 50 enters the motion display region 17ₖ from any motion display region of the motion display regions 17₁ to 17ₖ₋₁ and the second detecting unit 21 detects a position on a plane Pₖ on an upper side of the motion display region 17ₖ where the finger 50 entered the motion display region 17ₖ. Specifically, it is recognized that the finger 50 moves to the motion display region 17ₖ when a position of the finger 50 is detected at a given sampling time in any motion display region of the motion display regions 17₁ to 17ₖ₋₁ above the motion display region 17ₖ and a position of the finger 50 is detected in the motion display region 17ₖ at a next sampling time. In addition, the position of the finger 50 detected in the motion display region 17ₖ at this point can be assumed to be the position where the finger 50 entered the motion display region 17ₖ (an x-y coordinate position of the finger 50 passing through the plane Pₖ). Alternatively, the position of the finger 50 last detected in any region of the motion display regions 17₁ to 17ₖ₋₁ may be considered to be the position where the finger 50 entered the motion display region 17ₖ, or an intersection point of a line connecting the positions of the finger 50 at the two sampling times described above with the plane Pₖ may be considered to be the position where the finger entered the motion display region 17ₖ.

A fourth detecting unit 25 detects that the finger 50 enters the decision region 18 from any motion display region 17ₖ of the motion display regions 17₁ to 17ₙ and a fifth detecting unit 26 detects a position on a plane Q on an upper side of the decision region 18 where the finger 50 entered the decision region 18. Specifically, it is recognized that the finger 50 moves from the motion display region 17ₖ to the decision region 18 when a position of the finger 50 is detected at a given sampling time in the motion display region 17ₖ and a position of the finger 50 is detected in the decision region 18 at a next sampling time. In addition, the position of the finger 50 detected in the decision region 18 at this point can be assumed to be the position where the finger 50 entered the decision region 18 (an x-y coordinate position of the finger 50 passing through the plane Q). Alternatively, the position of the finger 50 detected in the motion display region 17ₖ may be considered to be the position where the finger entered the decision region 18, or an intersection point of a line connecting the positions of the finger 50 at the two sampling times described above with the plane Q may be considered to be the position where the finger entered the decision region 18.

Next, detection in a case where the finger 50 moves away from the display surface 11a will be described.

A sixth detecting unit 31 detects that the finger 50 entered any motion display region 17ₖ of the motion display regions 17₁ to 17ₙ from the decision region 18 and an eighth detecting unit 34 detects a position on a plane Pₖ₊₁ on a lower side of the motion display region 17ₖ where the finger 50 entered the motion display region 17ₖ. Specifically, it is recognized that the finger 50 moves from the decision region 18 to the motion display region 17ₖ when a position of the finger 50 is detected at a given sampling time in the decision region 18 and a position of the finger 50 is detected in the motion display region 17ₖ at a next sampling time. In addition, the position of the finger 50 detected in the motion display region 17ₖ at this point can be assumed to be the position where the finger 50 entered the motion display region 17ₖ (an x-y coordinate position of the finger 50 passing through the plane Pₖ₊₁). Alternatively, the position of the finger 50 last detected in the decision region 18 may be considered to be the position where the finger 50 entered the motion display region 17ₖ, or an intersection point of a line connecting the positions of the finger 50 at the two sampling times described above with the plane Pₖ₊₁ may be considered to be the position where the finger 50 entered the motion display region 17ₖ.

A third detecting unit 24 detects that the finger 50 enters the motion display region 17ₖ (where 1≦k≦n, k is a natural number) from any of the motion display regions 17ₖ₊₁ to 17ₙ and a seventh detecting unit 33 detects a position on a plane Pₖ₊₁ on a lower side of the motion display region 17ₖ where the finger 50 entered the motion display region 17ₖ. Specifically, it is recognized that the finger 50 moves to the motion display region 17ₖ when a position of the finger 50 is detected at a given sampling time in any motion display region of the motion display regions 17ₖ₊₁ to 17ₙ and a position of the finger 50 is detected in the motion display region 17ₖ at a next sampling time. In addition, the position of the finger 50 detected in the motion display region 17ₖ at this point can be assumed to be the position where the finger 50 entered the motion display region 17ₖ (an x-y coordinate position of the finger 50 passing through the plane Pₖ₊₁). Alternatively, the position of the finger 50 last detected in any motion display region of the motion display regions 17ₖ₊₁ to 17ₙ may be considered to be the position where the finger 50 entered the motion display region 17ₖ, or an intersection point of a line connecting the positions of the finger 50 at the two sampling times described above with the plane Pₖ₊₁ may be considered to be the position where the finger entered the motion display region 17ₖ.

In addition, the third detecting unit 24 detects that the finger 50 enters the non-detection region 19 from any motion display region 17ₖ of the motion display regions 17₁ to 17ₙ and the seventh detecting unit 33 detects a position on a plane P₁ where the finger 50 entered the non-detection region 19. Specifically, it is recognized that the finger 50 moves from the motion display region 17ₖ to the non-detection region 19 when a position of the finger 50 is detected at a given sampling time at a position in the motion display region 17ₖ and a position of the finger 50 is not detected at a next sampling time. Furthermore, the position in the motion display region 17ₖ where the finger 50 is detected at this point can be assumed to be the x-y coordinate position on the plane P₁ of the finger 50 upon entry to the non-detection region 19.

Moreover, an example of the n-number of types of predetermined distances according to the present invention corresponds to a length that is a sum of Z1₁ and a thickness h (refer to FIG. 2(A)) of the contactless input unit 15, a length that is a sum of Z1₂ and h, . . . , and a length that is a sum of Z1ₙ and h.

Next, operations of the information terminal 60 according to the present third embodiment will be described using an example where n=9.

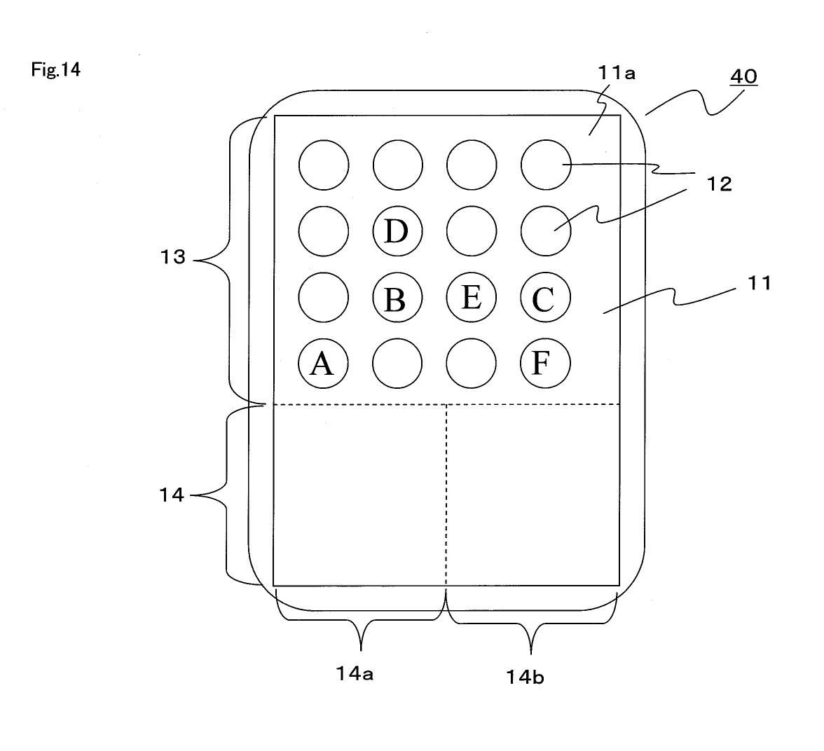

First, display positions of icons 12A, 12B, and 12C in a periphery of a change icon 30 will be described. FIGS. 17(A) and 17(B) are diagrams illustrating positions to where the icons 12A, 12B, and 12C are motion-displayed when display positions of the change icon 30 differ.

As illustrated in FIGS. 17(A) and 17(B), positions where the icons 12A, 12B, and 12C are displayed are determined in advance by a display position of the change icon 30. In other words, when the change icon 30 is displayed on a left end as illustrated in FIG. 17(A), the icons 12A, 12B, and 12C are displayed in the periphery to the right-hand side of the change icon 30, and when the change icon 30 is displayed at the center as illustrated in FIG. 17(B), the icons 12A, 12B, and 12C are evenly displayed in the periphery to the left and the right of the change icon 30. As shown, the positions where the icons 12A, 12B, and 12C are displayed (hereinafter, also referred to as arrival positions) differ depending on the position where the change icon 30 is displayed.

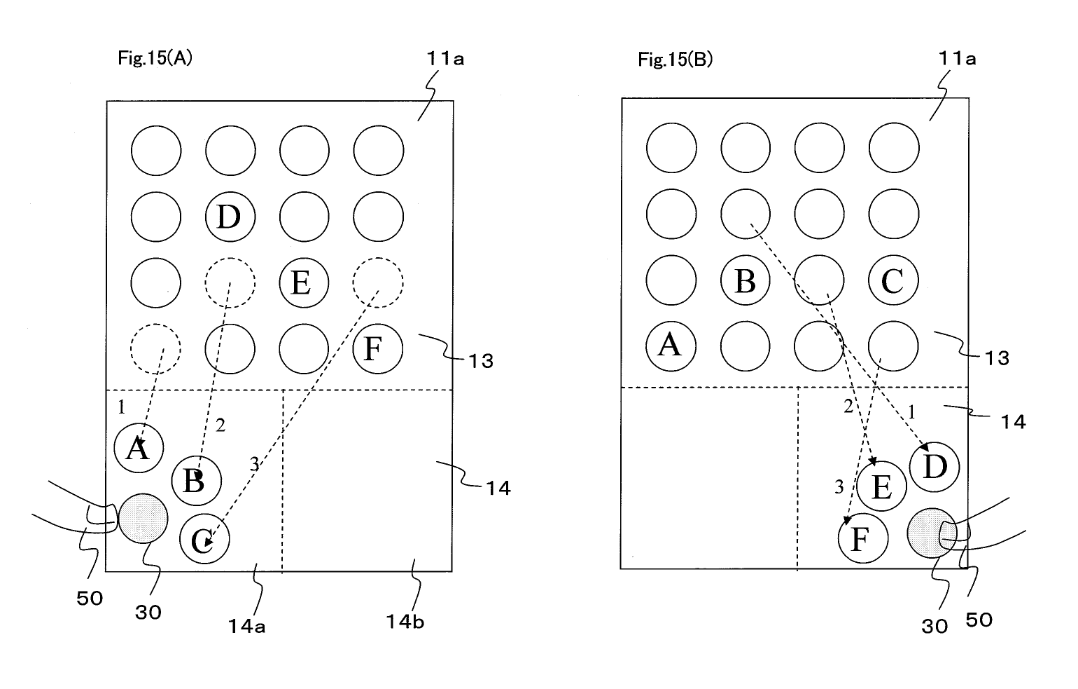

FIGS. 18 to 23 are diagrams for describing operations of the information terminal 60 according to the present third embodiment. In the respective drawings, (A) represents a plan view illustrating the display surface 11a of the information terminal 60 according to the present third embodiment and (B) represents a bottom view of the information terminal 60 according to the present third embodiment.

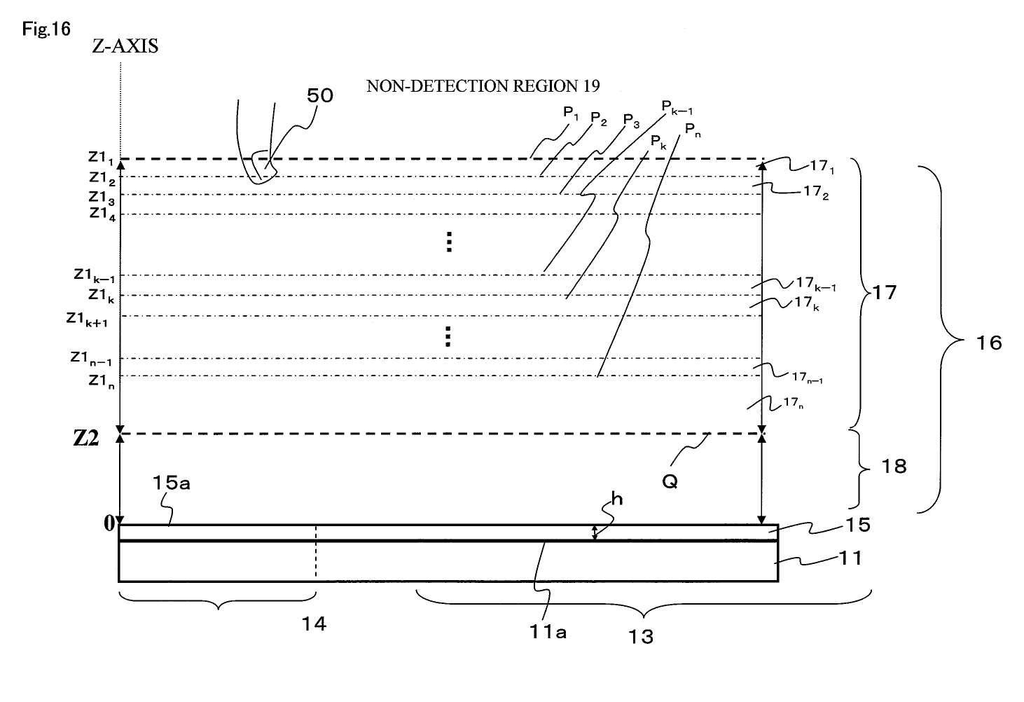

FIGS. 18(A) and 18(B) are diagrams illustrating an initial state of the information terminal 60. From such a state, when the finger 50 enters the motion display region 17₁ from the non-detection region 19 in a space above the detection area 14 of the display surface 11a as illustrated in FIGS. 19(A) and 19(B), the first detecting unit 20 detects that the finger 50 enters the motion display region 17₁ from the non-detection region 19 and the second detecting unit 21 detects a position where the finger 50 entered the motion display region 17₁. Subsequently, as illustrated in FIGS. 19(A) and 19(B), the change icon 30 is displayed directly underneath the position where the finger 50 entered the motion display region 17₁. Based on the position of the change icon 30, arrival positions of the icons 12A, 12B, and 12C are determined in advance and stored in a memory. In FIG. 19(A), the arrival positions of the icons 12A, 12B, and 12C are respectively indicated by the dashed-dotted lines as A₁, B₁, and C₁.

The icon 12A is motion-displayed to a position one-third (approximately 0.33 times) the distance from a position in an initial state (refer to FIG. 18(A)) to an arrival position (refer to A₁ in FIG. 19(A)) of the icon 12A, the icon 12B is motion-displayed to a position one-sixth (approximately 0.17 times) the distance from a position in an initial state (refer to FIG. 18(A)) to an arrival position (refer to B₁ in FIG. 19(A)) of the icon 12B, and the icon 12C is motion-displayed to a position one-ninth (approximately 0.11 times) the distance from a position in an initial state (refer to FIG. 18(A)) to an arrival position (refer to C₁ in FIG. 19(A)) of the icon 12C.

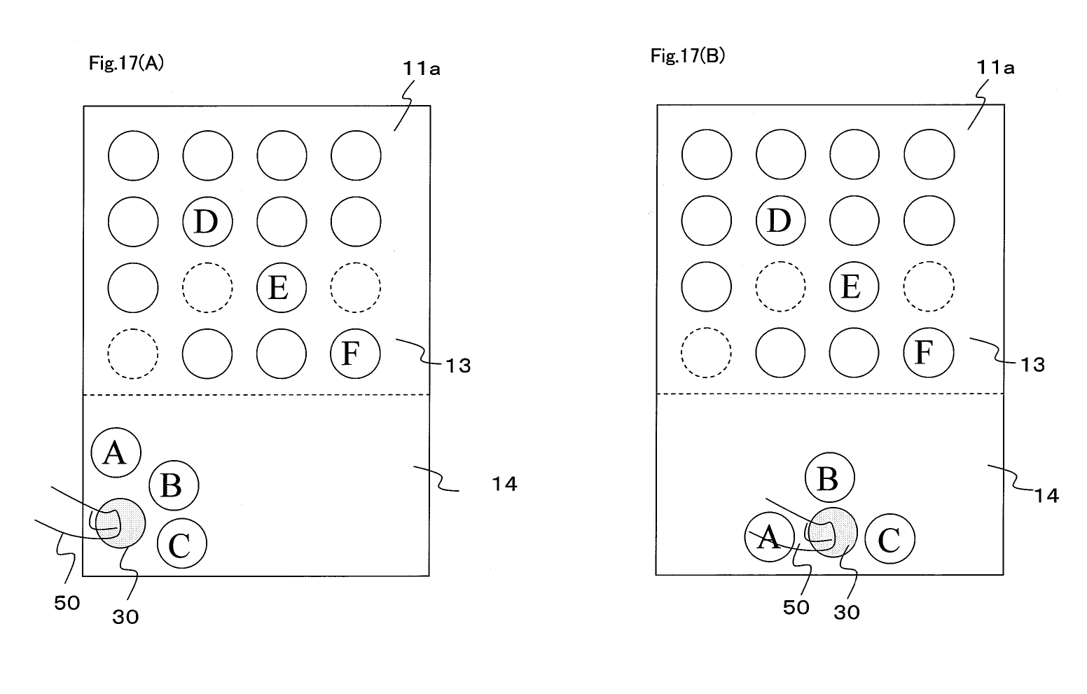

Next, as illustrated in FIGS. 20(A) and 20(B), when the finger enters a motion display region 17₂ from the motion display region 17₁, the first detecting unit 20 detects the movement of the finger 50 and the second detecting unit 21 detects a position where the finger 50 entered the motion display region 17₂, and the change icon 30 is motion-displayed directly underneath the detected position. In this case, since the change icon 30 moves in accordance with the movement of the finger, arrival positions in the periphery of the change icon 30 at which the icons 12A, 12B, and 12C arrive also change. In FIG. 20(A), the arrival positions of the icons 12A, 12B, and 12C are respectively indicated by the dashed-dotted lines as A₂, B₂, and C₂.

Subsequently, the icon 12A is motion-displayed from the display position illustrated in FIG. 19(A) to a position two-thirds (approximately 0.66 times) the distance from the position in the initial state (refer to FIG. 18(A)) to the arrival position (refer to A₂ in FIG. 20(A)) of the icon 12A, the icon 12B is motion-displayed from the display position illustrated in FIG. 19(A) to a position two-sixths (approximately 0.33 times) the distance from the position in the initial state (refer to FIG. 18(A)) to the arrival position (refer to B₂ in FIG. 20(A)) of the icon 12B, and the icon 12C is motion-displayed from the display position illustrated in FIG. 19(A) to a position two-ninths (approximately 0.22 times) the distance from the position in the initial state (refer to FIG. 18(A)) to the arrival position (refer to C₂ in FIG. 20(A)) of the icon 12C.

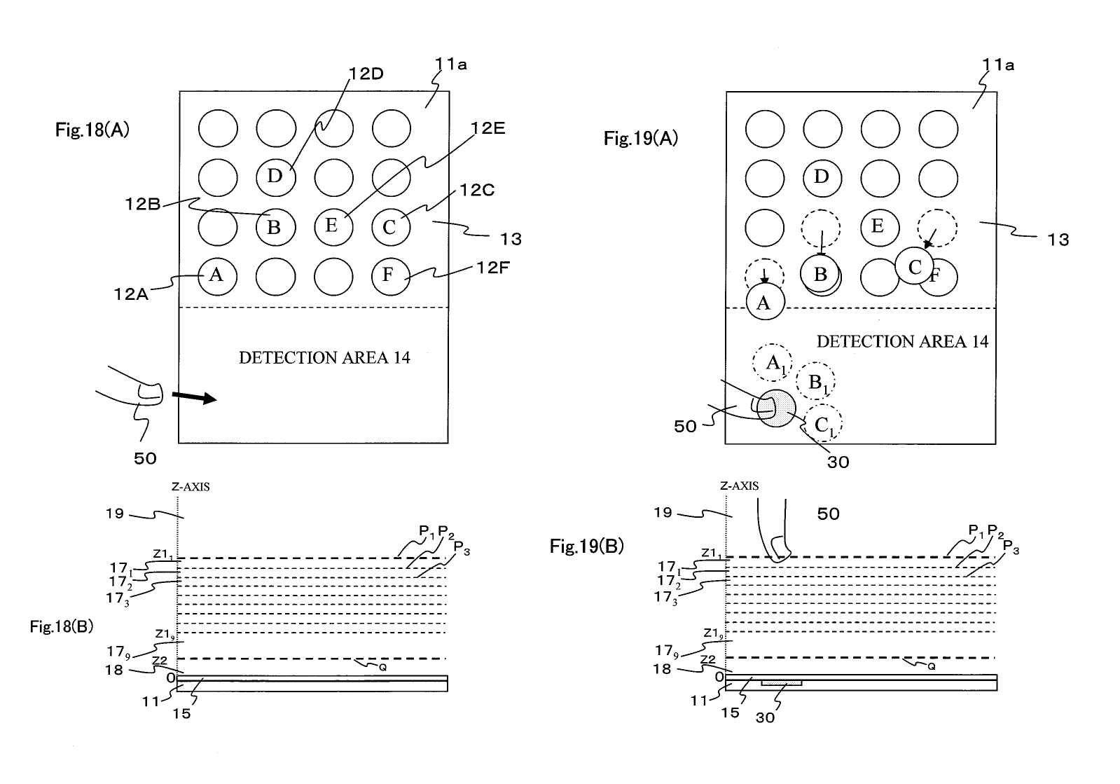

Next, as illustrated in FIGS. 21(A) and 21(B), when it is detected that the finger 50 enters a motion display region 17₃ from the motion display region 17₂, the change icon 30 is motion-displayed directly underneath the position where the finger 50 entered the motion display region 17₃, and the arrival positions of the icons 12A, 12B, and 12C are changed once again. In FIG. 21(A), the arrival positions of the icons 12B and 12C are respectively indicated by the dashed-dotted lines as B₃ and C₃.

Subsequently, the icon 12A is motion-displayed from the display position illustrated in FIG. 20(A) to the changed arrival position, the icon 12B is motion-displayed from the display position illustrated in FIG. 20(A) to a position three-sixths (approximately 0.5 times) the distance from the position in the initial state (refer to FIG. 18(A)) to the arrival position (refer to B₃ in FIG. 21(A)) of the icon 12B, and the icon 12C is motion-displayed from the display position illustrated in FIG. 20(A) to a position three-ninths (0.33 times) the distance from the position in the initial state (refer to FIG. 18(A)) to the arrival position (refer to C₃ in FIG. 21(A)) of the icon 12C. As shown, a computation performed based on a motion display region to which the finger 50 moves, arrival positions of icons in the periphery of the change icon 30 decided on in advance based on a position of the finger 50, and an initial position corresponds to an example of a display rule according to the present invention. In addition, an example of a position on the display surface obtained based on the display rule according to the present invention corresponds to positions to where the icons 12A, 12B, and 12C illustrated in FIGS. 19 to 22 are motion-displayed according to the present embodiment.

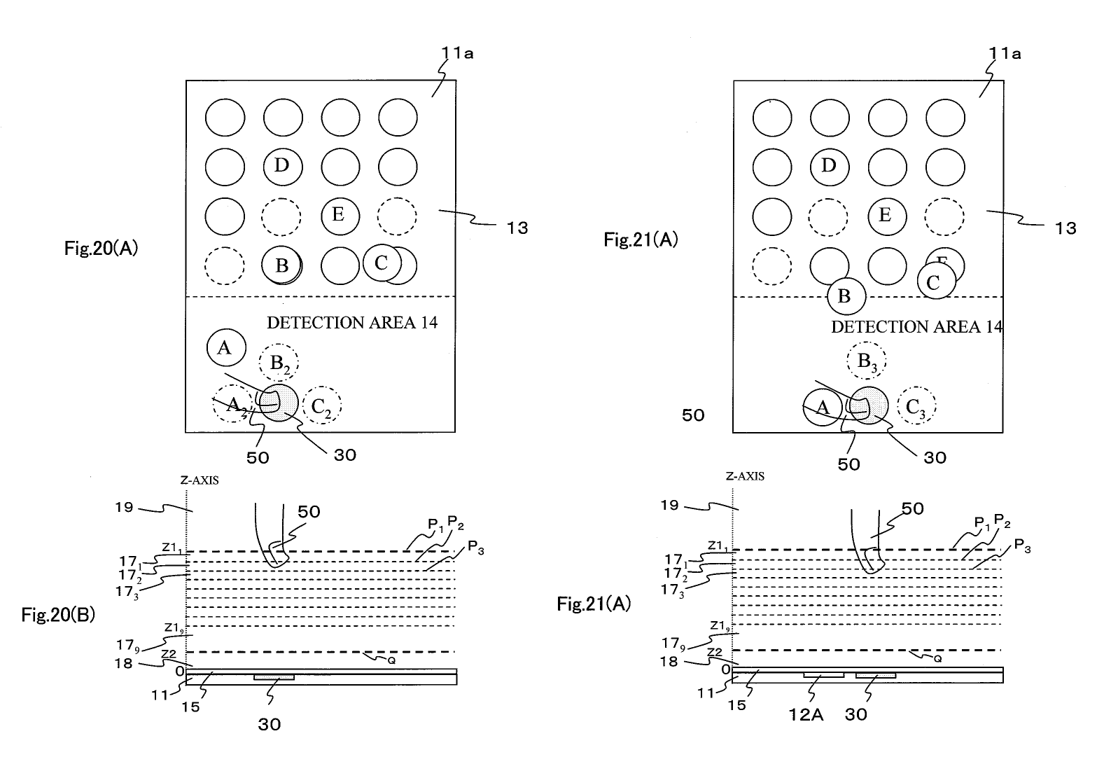

Similarly, as the finger 50 approaches the display surface 11A, the icons 12B and 12C are also motion-displayed in sequence, and when the finger 50 enters the motion display region 17₉, the icons 12A, 12B, and 12C are to be displayed at predetermined arrival positions in the periphery of the change icon 30 as illustrated in FIGS. 22(A) and 22(B). Moreover, as for the icons 12A and 12B, once the arrival positions are reached, the icons 12A and 12B are to be always motion-displayed to the arrival positions in the periphery of the change icon 30.

As shown, in the above example, the icon 12A is to be displayed at the arrival position thereof when the finger 50 moves to the motion display region 17₃, the icon 12B is to be displayed at the arrival position thereof when the finger 50 moves to the motion display region 17₆, and the icon 12C is to be displayed at the arrival position thereof when the finger 50 moves to the motion display region 17₉.

By performing control as described above, icons 12A, 12B, and 12C can be motion-displayed as though the icons gradually gather around the tip of the finger 50 of the user as the finger 50 approaches the display surface 11a. In addition, by increasing n, an appearance in which the icons gather more continuously can be achieved.

Moreover, while the icon 12A reaches the arrival position in the periphery of the change icon 30 when the finger 50 moves to the motion display region 17₃ in the display rule described above, the motion display region at the moment of arrival of the icon 12A may be arranged so as to be a different motion display region (for example, a motion display region 17₅). Furthermore, the motion-displayed positions at each display region may be changed. In this manner, settings of motion display regions when each icon is displayed at an arrival position and the motion-displayed positions of each icon in each motion display region can be arbitrarily changed.

In addition, while all of the icons 12A, 12B, and 12C are moved and displayed as the finger 50 enters the motion display region 17₁ in the above description, for example, a motion display of one of the icons may be arranged so as to start after another icon is motion-displayed to an arrival position. In this case, for example, at n=9, the motion display of the icon 12B is started after the icon 12A is motion-displayed to the arrival position at n=3, and the motion display of the icon 12C is started after the icon 12B is motion-displayed to the arrival position at n=6.

In essence, a position to where each icon is motion-displayed when the finger moves to each of the motion display regions 17₁ to 17ₙ should be set so that icons with higher priority orders are more quickly displayed at respective arrival positions thereof in the periphery of the change icon 30.

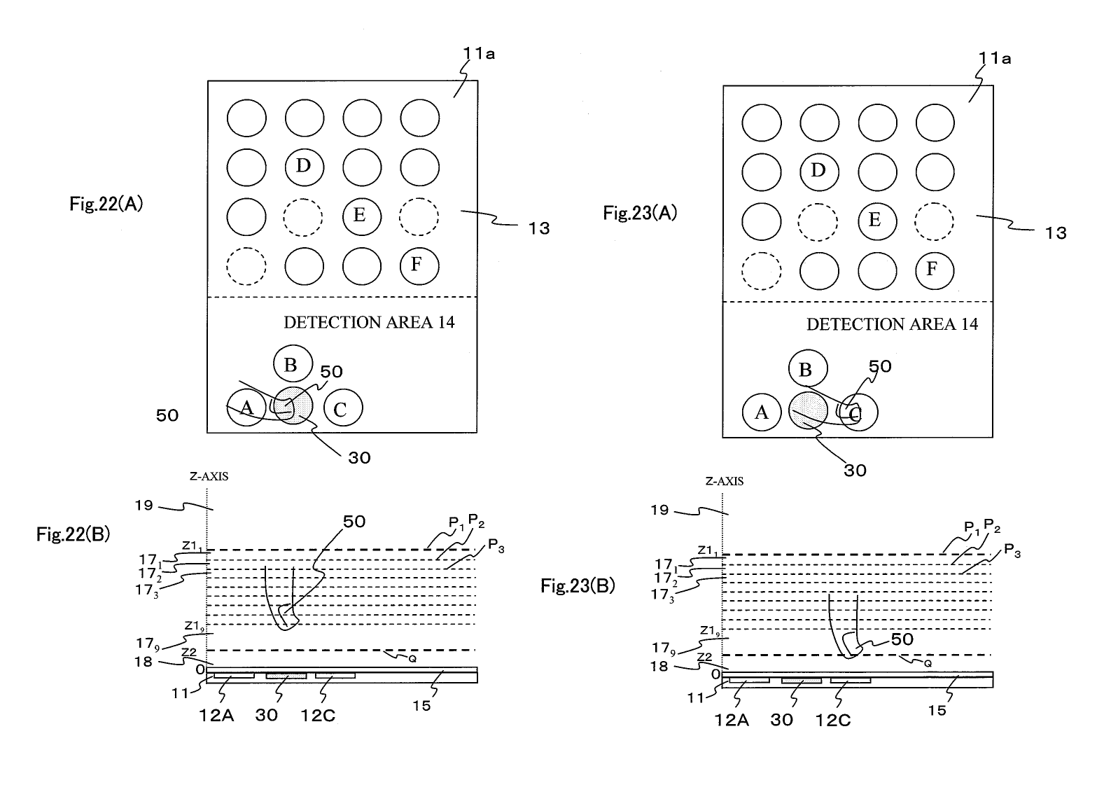

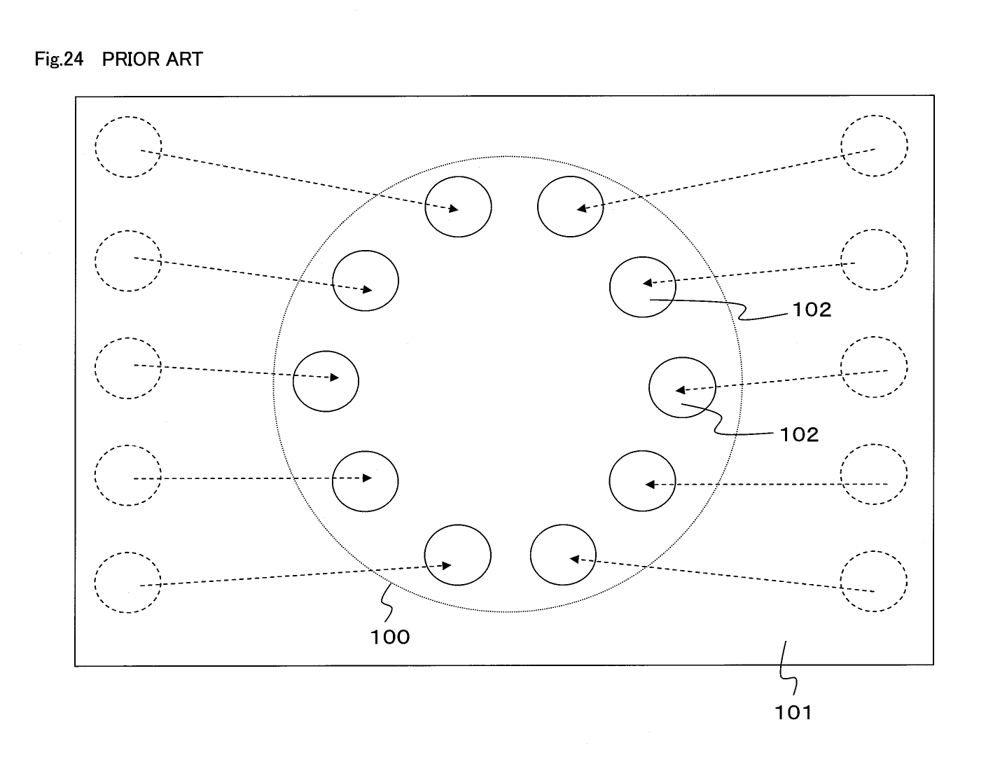

Next, from the state illustrated in FIGS. 22(A) and 22(B), when the finger 50 enters the decision region 18 from the motion display region 17₉ as illustrated in FIGS. 23(A) and 23(B), an icon directly underneath the position of entry of the finger 50 is decided on. In FIGS. 23(A) and 23(B), the icon 12C is to be decided on. When any one of the plurality of icons 12 is decided on in this manner, an application assigned to each icon is activated by the designating unit 28.

On the other hand, when the change icon 30 is decided on, in the same manner as in FIGS. 7(A) and 7(B), the icons 12A, 12B, and 12C are returned in sequence to original positions thereof, and the icons 12D, 12E, and 12F selected according to another predetermined selection rule are motion-displayed in sequence to predetermined positions in the periphery of the change icon 30. The predetermined positions in the periphery of the change icon 30 are decided on in advance and stored in the memory. The decision of the predetermined positions in advance corresponds to an example of the second display rule. In addition, an example of a position on the display surface obtained based on the second display rule according to the present invention corresponds to the predetermined position illustrated in FIG. 7(B) in the periphery of the change icon 30 according to the present embodiment.

Furthermore, when the finger 50 is separated from the display surface 11a in the motion display region 17 without deciding on any of the change icon 30 and the icons 12A, 12B, and 12C, the icons 12A, 12B, and 12C return to original states (initial positions) in an operation reverse to that illustrated in FIGS. 18 to 22.

In other words, when the finger 50 moves from a state where the finger 50 exists in the motion display region 17₉ (refer to FIG. 20) toward the motion display region 17₈ so as to become separated from the display surface 11a, the icon 12C is motion-displayed to a position one-ninth (approximately 0.11 times) the distance from the arrival position in the periphery of the change icon 30 toward the initial position. Next, when the finger 50 moves from the motion display region 17₈ to the motion display region 17₇, the icon 12C is motion-displayed from a previous display position to a position two-ninths (approximately 0.22 times) the distance from the arrival position in the periphery of the change icon 30 toward the initial position. In this case, the arrival position in the periphery of the change icon 30 moves in accordance with a movement of a horizontal position of the finger 50.

In addition, when the finger 50 moves from the motion display region 17₆ to the motion display region 17₅, the icon 12B is motion-displayed from a previous display position to a position one-sixth (approximately 0.17 times) the distance from the arrival position in the periphery of the change icon 30 toward the initial position, and the icon 12C is motion-displayed from a previous display position to a position four-ninths (approximately 0.44 times) the distance from the arrival position in the periphery of the change icon 30 toward the initial position.

Furthermore, when the finger 50 moves from the motion display region 17₃ to the motion display region 17₂, the icon 12A is motion-displayed from a previous display position to a position one-third (approximately 0.33 times) the distance from the arrival position in the periphery of the change icon 30 toward the initial position, the icon 12B is motion-displayed from a previous display position to a position four-sixths (approximately 0.67 times) the distance from the arrival position in the periphery of the change icon 30 toward the initial position, and the icon 12C is motion-displayed from a previous display position to a position seven-ninths (approximately 0.78 times) the distance from the arrival position in the periphery of the change icon 30 toward the initial position. Moreover, with such a movement of the finger 50 in a separating direction from the display surface 11a in the motion display region 17 as described above is detected by the third detecting unit 24 and the seventh detecting unit 33. In other word, the third detecting unit 24 detects a movement of the finger 50 from a lower-side region to an upper-side region and the seventh detecting unit 33 detects a position where the finger 50 entered the upper-side region.

As described above, when the finger 50 moves from the motion display region 17₁ to the non-detection region 19, all of the icons 12A, 12B, and 12C are returned to initial positions thereof. Moreover, in the control method described above, while all of the icons 12A, 12B, and 12C simultaneously are returned to initial positions thereof when the finger 50 moves from the motion display region 17₁ to the non-detection region 19, control may alternatively be performed to return the icons to initial positions one by one such that an icon starts to be returned to an initial position thereof after another icon is returned to an initial position thereof.

In addition, while the positions to where the icons 12A, 12B, and 12C are motion-displayed are obtained by computation in the description above, a position to where each of the icons 12A, 12B, and 12C is motion-displayed may alternatively be decided on in advance for each entry position of the finger 50 in each motion display region. In this case, a table of positions to where the icons are to be motion-displayed is stored in the memory and the icons are to be motion-displayed based on the table.

Moreover, while the finger 50 is consecutively detected for each of the motion display regions 17₁ to 17₉ in FIGS. 18 to 23, when n is increased in order to continuously display a movement of an icon, depending on a sampling interval, there may be cases where the finger 50 is detected in every other or every plurality of motion display regions. For example, when the finger approaches the display surface 11a, there may be a case where the finger 50 is first detected in the motion display region 17₁ and next detected in the motion display region 17₃. In such a case, when n=9, the respective icons 12A, 12B, and 12C are first displayed as illustrated in FIG. 19 and then motion-displayed from the display positions illustrated in FIG. 19 to the display positions illustrated in FIG. 21.

Moreover, in the first to third embodiments described above, the decision region 18 is provided and, when a finger moves from the motion display region 17 to the decision region 18, an icon displayed directly underneath the finger is to be decided on, thereby making the decision region 18 a decision region for icon decision. However, the decision region 18 need not be provided. In other words, a definite distance according to the present invention may take a value of zero. In this case, by using a touch panel employing a capacitance method, a decision on an icon can be detected when the display surface 11a is touched.

In addition, when a current function of the information terminals 10, 40, and 60 in the first to third embodiments described above is a home screen function, the icons 12 displayed on the display surface 11a are shortcut icons for activating various applications.

Furthermore, when a current function of the information terminals 10, 40, and 60 in the first to third embodiments described above is a music reproducing function, the icons 12 displayed on the display surface 11a are icons representing music contents. In this case, reduced screens of music albums and the like can be used as the icons.

Moreover, when the current function of the information terminals 10, 40, and 60 in the first to third embodiments described above is a video reproducing function, the icons 12 displayed on the display surface 11a are icons representing video contents. In this case, thumbnail images can be used as the icons. In addition, when the current function of the information terminals 10, 40, and 60 in the first to third embodiments described above is a photograph displaying function, the icons 12 displayed on the display surface 11a are icons representing photograph contents. In this case, reduced screens or thumbnail images can be used as the icons.

Moreover, while the change icon 30 is arranged so as to be displayed on the display surface 11a when the finger 50 enters the motion display region 17 in the embodiments described above, the change icon 30 need not be displayed. By at least having the icons motion-displayed one by one, the user can confirm at which positions the icons are displayed in the initial states. In this case, any one of the icons to be moved may be displayed at a position on the display surface 11a directly underneath the finger 50.

In addition, the icons need not necessarily be motion-displayed one by one, and may be moved simultaneously if there are only a small number of icons.

Furthermore, in the embodiments described above, while the icons 12 are arranged so as to be restored one by one even when restoring the icons 12 to their original states, all icons may be simultaneously restored to their original states instead.

Moreover, while the change icon 30 or the addition icon 32 is arranged so as to be displayed at a position on the display surface 11a directly underneath a finger in the embodiments described above, the change icon 30 or the addition icon 32 need not necessarily be displayed at a position on the display surface 11a directly underneath the finger and may alternatively be displayed at a position on the display surface 11a in the vicinity of the position directly underneath the finger.

In addition, a position of an icon to be motion-displayed may either be a position on the display surface 11a directly underneath the finger or a position on the display surface 11a in the vicinity of the position directly underneath the finger.

Furthermore, while sizes of the icons 12 are arranged so as to be the same in the embodiments described above, sizes of icons to be motion-displayed may be arranged in a descending order from the icon with the highest priority. In addition, a group of icons of a high-priority rule may be displayed larger than a group of icons of a low-priority rule. For example, if a rule for selecting the icons 12A, 12B, and 12C illustrated in FIG. 10 has a higher priority than a rule for selecting the icons 12D, 12E, and 12F, then the sizes of the icons 12A, 12B, and 12C are set to be larger than the sizes of the icons 12D, 12E, and 12F.

Moreover, while a priority is determined for each icon and the icons 12 are motion-displayed in a descending order of priorities in the embodiments described above, the icons 12 may alternatively be motion-displayed in sequence regardless of the priority order. For example, when a rule for selecting icons to be motion-displayed is a rule related to music genres or the like, a priority need not be determined for each icon and the icons may be motion-displayed in an order of registration to the information terminal or an order of proximity to the change icon 30.

In addition, while the detection area 14 is provided under the display surface 11a, the detection area 14 is not limited to this position and may alternatively be provided at the center as is the case of Japanese Patent Laid-Open No. 2008-117371 or be provided at an upper edge portion or a left/right edge portion.

Furthermore, an entire area on the display surface 11a in which icons 12 are not displayed may be considered to be a detection area.

In addition, while an example of a designating object according to the present invention corresponds to the finger 50 in the embodiments described above, such an arrangement is not restrictive and a pointing device such as a stylus may be used instead.

Moreover, a program according to the present invention is a program which causes operations of respective steps of the aforementioned screen component display method according to the present invention to be executed by a computer and which operates in cooperation with the computer.

In addition, a recording medium according to the present invention is a recording medium on which is recorded a program that causes a computer to execute for making a computer execute all of or a part of operation of the respective steps of the aforementioned screen component display method according to the present invention and which is a readable by the computer, whereby the read program performs the operations in collaboration with the computer.

Furthermore, the aforementioned “operations of the respective steps” of the present invention refer to all of or a part of the operations of the step described above.

Moreover, one utilizing form of the program of the present invention may be an aspect of being recorded on a recording medium, ROM and the like are included, which can be read by a computer, and operating with collaborating with the computer.

In addition, one utilizing form of the program of the present invention may be an aspect of being transmitted inside a transmission medium, transmission media such as the Internet, light, radio waves, and acoustic waves and the like are included, being read by a computer, and operating with collaborating with the computer.

Furthermore, a computer according to the present invention described above is not limited to pure hardware such as a CPU and may be arranged to include firmware, an OS and, furthermore, peripheral devices.

Moreover, as described above, configurations of the present invention may either be realized through software or through hardware.

The information terminal and the screen component display method according to the present invention enable a desired screen component to be easily found and an original state prior to movement of a screen component to be easily discerned, and is useful as an information terminal of a smartphone, a PDA, and the like.

What is claimed is:

1. An information terminal comprising:
a display surface that displays a plurality of screen components;
a motion display detecting unit that detects information related to a distance from the display surface to a designating object that designates the screen components, and information related to a position of the designating object in a plane parallel to the display surface; and
a screen component movement rendering unit that motion-displays in sequence the screen components selected according to a selection rule, to such positions on the display surface obtained according to a display rule, based on the information related to the distance and the information related to the position.

2. The information terminal according to claim 1, wherein the display rule refers to a position directly underneath the detected position or a vicinity of the position directly underneath the detected position.

3. The information terminal according to claim 1, wherein the selection rule refers to selecting the screen components based on a genre or a decision history.

4. The information terminal according to claim 1, wherein the sequence refers to an order determined based on a decision history.

5. The information terminal according to claim 1, wherein when the motion display detecting unit detects that the designating object is separated from the display surface beyond a predetermined distance, the screen component movement rendering unit restores the motion-displayed screen components to respective original states before the motion display of the screen components.

6. The information terminal according to claim 1, further comprising
a decided position judging unit which, when the motion display detecting unit detects that the designating object enters within a definite distance that is shorter than a predetermined distance, of the display surface, and detects a position of the designating object in a plane parallel to the display surface, judges the screen component displayed at a position on the display surface directly underneath the detected position of the designating object and detects that the judged screen component is decided on by the designating object.

7. The information terminal according to claim 6, further comprising
a change screen component displaying unit which, when the motion display detecting unit detects that the designating object enters within the predetermined distance of the display surface and detects a position of the designating object in a plane parallel to the display surface, displays a change screen component for changing the motion-displayed screen components to other screen components, at a position directly underneath the detected position of the designating object or in a vicinity of the position directly underneath the detected position of the designating object, wherein
when the decided position judging unit detects that the change screen component is decided on by the designating object, in order to perform the changing, the screen component movement rendering unit restores the motion-displayed screen components to original states before the motion display of the screen components and motion-displays in sequence screen components selected based on a second selection rule that differs from the selection rule, to such positions on the display surface obtained according to a second display rule that differs from the display rule, based on the position of the designating object detected by the motion display detecting unit.

8. The information terminal according to claim 6, further comprising
an addition screen component displaying unit which, when the motion display detecting unit detects that the designating object enters within the predetermined distance of the display surface and detects a position of the designating object in a plane parallel to the display surface, displays an addition screen component for adding another screen component to the motion-displayed screen components, at a position directly underneath the detected position of the designating object or in a vicinity of the position directly underneath the detected position of the designating object, wherein
when the decided position judging unit detects that the addition screen component is decided on by the designating object, in order to perform the adding, the screen component movement rendering unit does not restore the motion-displayed screen components to original states before the motion display of the screen components and motion-displays in sequence screen components selected based on a second selection rule that differs from the selection rule, to such positions on the display surface obtained according to a second display rule that differs from the display rule, based on the position of the designating object detected by the motion display detecting unit.

9. The information terminal according to claim 5, wherein the screen component movement rendering unit restores the motion-displayed screen components in a determined sequence when restoring the motion-displayed screen components to original states before the motion display of the screen components.

10. The information terminal according to claim 7, wherein when the change screen component is decided on by the designating object, the change screen component displaying unit erases the change screen component.

11. The information terminal according to claim 8, wherein when the addition screen component is decided on by the designating object, the addition screen component displaying unit erases the addition screen component.

12. The information terminal according to claim 1, wherein groups of the selected screen components to be motion-displayed at least partially differ from each other according to a position of the designating object detected by the motion display detecting unit.

13. The information terminal according to claim 1, wherein the motion display detecting unit includes a capacitance panel arranged adjacent to the display surface in order to detect, by a capacitance method, the information related to a distance from the display surface to the designating object that designates the screen components, and the information related to a position of the designating object in a plane parallel to the display surface.

14. The information terminal according to claim 1, wherein the information related to a distance from the display surface to a designating object designating the screen components, refers that the designating object designating the screen components enters respectively within n-number (where n is a natural number equal to or greater than 1) types of predetermined distances of the display surface.

15. A screen component display method comprising:
a display step of displaying a plurality of screen components;
a motion display detecting step of detecting information related to a distance from the display surface to a designating object that designates the screen components, and information related to a position of the designating object in a plane parallel to the display surface; and
a screen component movement rendering step of motion-displaying in sequence the screen components selected according to a selection rule, to such positions on the display surface obtained according to a display rule, based on the information related to the distance and the information related to the position.

16. A program embodied on a non-transitory computer-readable medium, the program causing a computer to execute the screen component display method according to claim 15.

17. The information terminal according to claim 7, wherein the screen component movement rendering unit restores the motion-displayed screen components in a determined sequence when restoring the motion-displayed screen components to original states before the motion display of the screen components.
